(19) United States
(12) Patent Application Publication
(10) Pub. No.: US 2009/0179736 A1
(43) Pub. Date: Jul. 16, 2009

(54) SETTING DEVICE, BIOMETRIC DEVICE, BIOMETRIC DEVICE SETTING SYSTEM, BIOMETRIC DEVICE SETTING METHOD, PROGRAM, AND COMPUTER-READABLE RECORDING MEDIUM

(76) Inventors: Yumi Shiraishi, Nara (JP); Katsuya Nakagawa, Kyoto (JP)

Correspondence Address: BIRCH STEWART KOLASCH & BIRCH, PO BOX 747, FALLS CHURCH, VA, 22040-0747, US

(21) Appl. No.: 12/305,454

(22) PCT Filed: Jun. 19, 2007
(86) PCT No.: PCT/JP2007/062294

§ 371 Date: Dec. 18, 2008

(30) Foreign Application Priority Data
Jun. 20, 2006 (JP) 2006-170321

(51) Int. Cl. G06F 7/04

(52) U.S. Cl. 340/5.82

(57) ABSTRACT

Setting of a biometric device is easily carried out. A setting device (7) includes: a storage section for storing (i) personal or physical information to be set in a biometric device (101), and (ii) output mode information indicative of an output mode of a measurement result measured by the biometric device (101); a setting request acquisition section (23) for acquiring a setting request, a device ID and a type ID; a setting information management section (27) for reading out, in a case where the setting request acquisition section (23) acquires the setting request, necessary personal and/or physical information and appropriate output mode information from the storage section (30); and a setting information output section (26) for notifying the biometric device (101) of various setting contents indicated by various information read out by the setting information management section (27).

### TECHNICAL FIELD

The present invention relates to a setting device for carrying out a setting of a biometric device that measures various information of a living body, and particularly relates to a setting device which notifies information required for setting a biometric device such as a body fat scale, a pedometer, a blood pressure monitor, or a sphygmograph. In addition, the present invention relates to such the biometric device, a biometric device setting system, a biometric device setting method, a program, and a computer-readable recording medium.

### BACKGROUND ART

Recently, along with an expansion of the “health care” market, various devices such as body fat scales, pedometers, blood pressure monitors, and sphygmographs have been commercialized as devices that measure biometric information (hereinafter referred to as “biometric device”). Some devices that are currently in the market require entering of personal and/or physical information such as height, age, and sex, so as to carry out accurate measurement and appropriate diagnosis of body fat ratio, muscle rate, visceral fat ratio and the like. It is assumed that such entering of personal information would become necessary for more devices, due to an enhancement of consideration towards health, and development of various services such as health management services and in-house medical services that are provided in coordination with these devices.

A system for managing measured biometric information in a network server such as a broadband network or LAN is also beginning to be considered. In such a case, a need to enter information in order to connect a biometric device to a network and communicate with a server would also occur for each of the biometric devices.

However, usually, an operation section in the biometric device for carrying out settings is insufficient. Therefore, when individuals start to possess numeral biometric devices due to the diversification of them, it is assumed that setting of personal information, communication and the like to each of the devices one by one would become intricate. Moreover, in a case where one device is used between a multiple number of people, repetitive entering of the setting for a person who is to use the device is required at the time of use.

Patent Document 1 discloses a system which automatically carries out a setting to a digital camera in order to accommodate to an individual. More specifically, an arrangement is disclosed such that, a watch-type setting data recording device stores setting data of a user who possesses the device, and the setting data is transmitted to the digital camera via wireless communication from the setting data recording device if necessary.

### [Patent Document 1]

Japanese Unexamined Patent Publication No. 132374/2002 (Tokukai 2002-132374; published on May 10, 2002)

### DISCLOSURE OF INVENTION

However, a setting device for carrying out an automatic setting to a biometric device has still not been developed. As described above, a number of biometric devices that are used daily by an individual is remarkably increasing, along with the increase in desiring for a healthy life in recent years. Many elderly people are also users of the biometric devices, however it is not rare that entering of the setting information to the biometric devices is difficult for them.

The present invention is attained in view of the conventional problems, and its object is to allow easy settings of a biometric device.

In order to attain the object, a setting device according to the present invention is a setting device for setting a biometric device that measures information related to a living body, the setting device including: a setting information storage section for storing a plurality of setting information indicative of setting contents to be applied to the biometric device; a device information acquisition section for acquiring device information related to the biometric device; a setting information management section for reading out, from the setting information storage section, one or more of the setting information based on the device information acquired by the device information acquisition section; and a setting information output section for notifying the biometric device of at least one of the setting contents indicated by the setting information read out by the setting information management section.

Moreover, in order to attain the object, a system for setting a biometric device according to the present invention is a system including: a biometric device for measuring biometric information; and a setting device for setting the biometric device, the setting device including: a setting information storage section for storing a plurality of setting information indicative of setting contents to be applied to the biometric device; a device information acquisition section for acquiring device information related to the biometric device; a setting information management section for reading out, from the setting information storage section, one or more of the setting information based on the device information acquired by the device information acquisition section; and a setting information output section for notifying the biometric device of at least one of the setting contents indicated by the setting information read out by the setting information management section, and the biometric device including: a device information notification section for notifying the device information to the setting device; a setting content acquisition section for acquiring a setting content to be notified from the setting device; and a setting section for carrying out a setting based on the setting content acquired by the setting content acquisition section.

Furthermore, in order to attain the object, a method according to the present invention for setting a biometric device is a method for setting, by use of a setting device, a biometric device that measures biometric information, the method including: a device information acquisition step of acquiring device information related to the biometric device by use of the setting device; a setting information management step of reading out, by use of the setting device, one or more of setting information from a setting information storage section based on the device information acquired in the device information acquisition step, the setting information storage section storing a plurality of setting information indicative of setting contents to be applied to the biometric device; and a setting information output step of notifying to the biometric device, by use of the setting device, at least one of the setting contents indicated by the setting information read out in the setting information management step.

According to the arrangement, setting information is read out from a setting information storage section by a setting information management section (setting information management step), based on device information related to a biometric device, and setting contents indicated by the setting information thus read out is notified to the biometric device by a setting information output section (setting information output step). Storage of the setting information in the storage section of the setting device in advance as such allows elimination of requiring a user to carry out complex operations at a time when setting is required, such as at a time of use of the biometric device.

One application example is, even in a case where a user of the biometric device is an elderly person for example, if the setting information is entered to a storage section of a setting device by a medical professional in a medical institution or the like, it is possible for the elderly person to use the biometric device without having to carry out the complex settings by themselves. Moreover, even in a case where a multiple number of users share a biometric device, the biometric device no longer requires the user to carry out settings of complex operations each time the biometric device is used.

The setting information management section selects and reads out setting information that contains at least one of the setting contents to be notified to the biometric device among the plurality of setting information stored in the setting information storage section, based on the device information acquired by the device information acquisition section. Therefore, appropriate settings are carried out in accordance with the biometric device that is to be set.

As described above, with the present invention, various settings of the biometric device can be carried out without a user having to carry out any complex operations to the biometric device.

The device information may be information for specifying a type of setting information required for setting the biometric device. More specifically, the device information may be: unique identification information of the biometric device (for example a serial number or IP address), information indicative of a type of the biometric device (for example body fat scale, sphygmograph or the like) that is classified based on a measurement item, a model number of the biometric device, or a combination of these information.

A kind of setting content to be set to the biometric device differs depending on the type of the biometric device. However, with the arrangement, an appropriate setting content is notified to the biometric device in accordance with the type of the biometric device.

The setting information storage section may store, as the setting information, physical or personal information of a user who is to be measured by the biometric device.

Some recent biometric devices require physical and/or personal information of a user in order to carry out measurement of biometric information or to carry out simple diagnosis based on a measurement result of the biometric information. For example, some weight scales that are capable of carrying out measurement and diagnosis of body fat ratio require entering of height and age of a user. According to the arrangement, the setting information storage section stores physical and/or personal information of a user; when a biometric device notifies the setting device of a setting request, the setting device notifies to the biometric device the physical and/or personal information. Therefore, setting of the physical and/or personal information that is required when the biometric device carries out measurement is easily carried out.

It is preferable for the setting device to further include a validity period storage section for storing validity period information indicative of a validity period of respective setting information stored in the setting information storage section; and a notification section for notifying a user in a case where the validity period is detected to have elapsed, the validity period being measured starting upon preparation or registration of the setting information stored in the setting information storage section and being indicated by the validity period information stored in the validity period storage section. Some of the physical or personal information that are notified to the biometric device change in elapse of time, and such information are better updated once every predetermined period. According to the arrangement, in a case where the validity period is detected to have elapsed, which validity period is measured starting upon preparation or registration of the setting information, the notification section notifies a user of the elapse. This allows prevention of a problem of the user which forgets to update the physical and/or personal information, which results in abandoning of the information for a long period of time.

Moreover, it is preferable for the setting device to further include a setting item storage section for storing the device information and a setting information identifier so that the device information and the setting information identifier correspond to each other, the setting information identifier being an identifier for specifying a respective setting information, the setting information storage section (i) storing the setting information for a plurality of items, and (ii) storing each of the setting information so that the setting information corresponds to a respective setting information identifier, the setting information management section (i) reading out, from the setting item storage section, a setting information identifier that corresponds to the device information acquired by the device information acquisition section, and (ii) selecting, from the setting information storage section, setting information that corresponds to the setting information identifier thus read out, and the setting information output section notifying the biometric device of a setting content indicated by the setting information selected by the setting information management section.

The technique of Patent Document 1 requires preparation of setting information for each device to be set, as like in profiling. Therefore, there are disadvantages such that a set of setting information (setting file) has to be prepared per device to be set, and such set of setting information can only be applied to one of the devices to be set. This lacks in practicality.

In comparison, according to the arrangement of the present invention, the setting information storage section stores setting information such as physical and personal information for a plurality of items. An identifier of an item required for setting the biometric device to be set is read out from the setting item storage section based on the device information, so as to select, from the setting information storage section, the setting information corresponding to the identifier thus read out. Therefore, in setting of a plurality of biometric devices that require different items of setting information, it is possible to share the setting information of the items commonly used between the plurality of biometric devices; preparation of a set of setting information per biometric device is not required. As such, integral management of the setting information that ranges in a plurality of items allows improvement in efficiency of management of the setting information.

Moreover, it is preferable such that the setting information storage section (i) stores the setting information for a plurality of items, and (ii) stores each of the setting information so that the setting information corresponds to a confidentiality degree indicative of a degree of confidentiality of respective setting information, the setting information management section selects one or more of setting information among the setting information stored in the setting information storage section, based on a comparison of the confidentiality degree stored in the setting information storage section and a predetermined threshold, and the setting information output section notifies the biometric device of at least one of setting contents indicated by the setting information selected by the setting information management section.

Some of the physical and personal information to be set to the biometric device are desirably not known by third parties, such as weight, age, and the like. According to the arrangement, the setting information corresponds to the confidentiality degree indicative of a degree of confidentiality of respective setting information. Accordingly, the setting information management section selects the setting information from the storage section based on a comparison of the confidentiality degree and a threshold. Therefore, some setting information will not be selected, depending on the comparison of the confidentiality degree and the threshold. As such, the setting information that is desirably not known by the third parties is determined based on the confidentiality degree. This allows not notifying such setting information to the biometric device. As a result, it is possible to provide a setting environment in consideration of privacy of a user.

Moreover, the setting device may further include a notification section, the setting information storage section (i) storing the setting information for a plurality of items, and (ii) storing the setting information so that the setting information corresponds to a confidentiality degree indicative of a degree of confidentiality of respective setting information, the setting information management section comparing the confidentiality degree stored in the setting information storage section with a predetermined threshold, and in accordance with a comparison result by the setting information management section, the notification section asking a user whether or not to notify the biometric device of at least one of the setting contents indicated by the setting information.

According to the arrangement, the physical or personal information that are desirably not known by the third parties are determined based on the confidentiality degree. This enables to ask a user whether or not such content is to be notified to the biometric device. Therefore, it is possible to provide a setting environment in consideration of privacy of a user.

Note that, it is preferable for the setting information management section to compare the confidentiality degree with a threshold set based on device information acquired by the device information acquisition section.

According to the arrangement, the threshold is based on device information of the biometric device. Namely, the threshold is a value adapted to the biometric device that is to be set. This allows appropriate determination with respect to the biometric device that is to be set. The device information here encompass, for example, identification or type information of the biometric device, location information indicative of a location of the biometric device, setting information output mode information indicative of an output mode of the setting information to the biometric device, and safety degree information indicative of a degree of safety of the output mode of the setting information to the biometric device.

Alternatively, the threshold may be based on a degree of safety of how the setting information output section notifies the biometric device.

According to the arrangement, whether or not a setting content is notified to the biometric device, or whether or not a user is asked whether or not to notify the setting content to the biometric device is decided depending on a comparison of a confidentiality degree of the setting information and a degree of safety of a notification mode. Therefore, for example, in a case where safety of a notification mode cannot be secured (i.e., in a case of a notification mode that can easily be observed), contents of specific setting information can be not notified to the measuring device, or can be entrusted to a user in determination of whether or not to notify the measuring device.

Note that the confidentiality degrees are preferably settable by a user.

Moreover, it is preferable for the setting device to further include a notification section for notifying a user; and a timing section, the setting information storage section storing the setting information so that the setting information corresponds to a time at which the setting information is prepared or updated, and the notification section notifying to the user an elapse of a predetermined period when the elapse is detected based on the time and the timing section after the setting information is prepared or updated.

Some physical or personal information that are notified to the biometric device change due to elapse of time, and such information are preferably updated each predetermined period. According to the arrangement, in a case where the elapse is detected based on the time and the timing section after an update of the setting information, the notification section notifies the user of the elapse. This enables prevention of a problem of the user forgetting to update the physical or personal information, which results in abandoning of the information for a long period of time.

It is preferable for the setting information storage section to store the setting information for a plurality of items, and the predetermined period varies depending on the items of the setting information.

According to the arrangement, it is possible to appropriately determine a timing for updating setting information in accordance with a type of physical or personal information.

Note that, the notification section may notify the user so as to encourage updating of the setting information.

Moreover, the setting device may be arranged such that the setting information storage section stores, as the setting information, one or more output mode information indicative of one or more output modes of respective one or more measurement results measured by the biometric device, the device information is information for specifying a respective measurement item of the biometric device, the setting information management section specifies the measurement item of the biometric device based on the device information acquired by the device information acquisition section so as to select, based on the measurement item thus specified, the output mode information from the setting information storage section, and the setting information output section notifies the biometric device of a setting content indicated by the output mode information selected by the setting information management section.

It is conventionally common for the biometric device, when a measurement result measured by a biometric device is notified to a user, to just have a mode for displaying the measurement result on a display section incorporated in the biometric device. However, along with advancement in recent biometric devices, various output modes of the measurement result have become settable. According to the arrangement, the setting information storage section stores output mode information indicative of one or more output modes of respective one or more measurement results measured by the biometric device. When the biometric device notifies a setting request to the setting device, a measuring device notifies, to the biometric device, an output mode indicated by the output mode information. Consequently, it is possible to easily set the output mode that is required when the biometric device outputs the measurement result.

Further, among the measurement items to be measured by the biometric device, some results of the items measured are desirably not known by third parties, for example weight or the like. According to the arrangement, the setting information management section selects the output mode information based on the measurement item of the biometric device. As a result, it is possible to set the biometric device so that the measurement result is notified to the user in a suitable output mode, in accordance with whether or not the measurement result is one which is desirably not known by the third parties. Thus, it is possible to set the biometric device so that the output mode is set in consideration of the privacy of the user.

Moreover, the setting device may further include a notification section for acquiring the measurement results so as to inform a user of them, the setting information storage section storing a plurality of output mode information including first output mode information and second output mode information, the first output mode information being indicative of an output mode for notifying the user of the measurement result by use of the biometric device, and the second output mode information being indicative of an output mode for notifying the user of the measurement result by use of the notification section.

According to the arrangement, the setting device (i) has a notification section for acquiring the measurement results from the biometric device so as to inform the user, (ii) selects, as an output mode of the measurement result, any one of a plurality of output mode information including first output mode information and second output mode information, the first output mode information being indicative of an output mode for informing the user of the measurement result by use of the biometric device, and the second output mode information being indicative of an output mode for informing the user of the measurement result by use of the notification section, and (iii) sets the biometric device so that the measurement result is outputted by the respective output mode thus selected. As a result, it is possible to carry out settings such as informing the biometric device, informing the setting device, and the like. Therefore, for example, in a case where biometric information is measured by use of a biometric device located in public, it is possible to carry out display as follows: for a measurement result such as height that has no damage in having a third party know of such information, the measurement result is displayed on the biometric device, however for a measurement result such as weight that is desirably not known by the third parties, the measurement result is displayed on a setting device held by the user.

Moreover, it is preferable for the setting device to further include a confidentiality degree storage section for storing a confidentiality degree so that the confidentiality degree corresponds to a respective measurement item of the biometric device, the confidentiality degree being indicative of a degree of confidentiality of the measurement item, the setting information management section reading out the confidentiality degree of a specified measurement item from the confidentiality degree storage section so as to select the output mode information from the setting information storage section based on the confidentiality degree thus read out.

Measurement items that are measured by the biometric device include items of which the measurement result is desirably not known by third parties, such as weight. According to the arrangement, the confidentiality degree storage section stores a confidentiality degree indicative of a degree of confidentiality of a respective measurement item, and the setting information management section selects output mode information based on the confidentiality degree of the measurement item. Consequently, whether or not the measurement result is one which is desirably not known by the third parties is determined based on the confidentiality degree. This enables to set the biometric device so that the measurement result is notified to the user in a suitable output mode. Thus, it is possible to set the biometric device so that the output mode is set in consideration of the privacy of the user.

It is preferable for the setting information storage section to store each of the output mode information so that the output mode information corresponds to a safety degree indicative of a degree of safety of a respective output mode, the degree of safety of the output mode being indicated by the output mode information, the setting information management section selects the output mode information from the setting information storage section based on the specified measurement item and the safety degree.

The output modes for outputting the measurement result measured by the biometric device includes output modes of various safety levels, from high to low. According to the arrangement, the setting information storage section stores, together with the output mode information, a safety degree indicative of a degree of safety of the output mode indicated by the output mode information, so that the output mode information corresponds to the output mode information. Accordingly, the setting information management section selects, from the output mode information that have different output modes, an output mode information indicative of an appropriate output mode, based on the safety degree corresponding to the output mode information. Therefore, it is possible to decide an output mode of the measurement result in consideration of the safety degree of the output mode.

Moreover, it is preferable for the setting device to further include a confidentiality degree storage section for storing a confidentiality degree so that the confidentiality degree corresponds to a respective measurement item of the biometric device, the confidentiality degree being indicative of a degree of confidentiality of a respective measurement item, the setting information storage section storing each of the plurality of output mode information so that the output mode information corresponds to a safety degree indicative of a degree of safety of the output mode, the degree of safety of the output mode being indicated by the output mode information, and the setting information management section reading out the confidentiality degree corresponding to the specified measurement item from the confidentiality degree storage section so as to select the output mode information from the setting information storage section based on the confidentiality degree thus read out and the safety degrees.

According to the arrangement, the output mode information indicative of the output mode of the measurement result is selected based on the respective confidentiality degree of the measurement result and the respective safety degree of the output mode. Therefore, it is possible to set the biometric device with the appropriate output mode in consideration of both the confidentiality of the measurement result and the safety degree of the output mode.

The setting information management section may select a plurality of candidates among the output mode information stored in the setting information storage section, and the setting information output section may notify the biometric device of an output mode indicated by any one of the output mode information that is specified by a user, among the candidates selected by the setting information management section.

According to the arrangement, the setting information management section selects a plurality of candidates of the output mode information, and reads out an output mode that is specified by a user among the selected candidates. Therefore, it is possible to set the output mode in consideration of wishes of a user.

Note that the confidentiality degrees and the safety degrees are preferably settable by the user.

The setting information storage section may store, as the setting information, registering destination information indicative of a destination at which the measurement result measured by the biometric device is to be registered.

Some recent biometric devices are connected to a server located in medical institutions and management companies that manage medical information, via a communication network, so as to fully register measurement results to the server. Although incorporation of such system allows realization of advanced medical services by use of daily measurement results in treatment and diagnosis, it is necessary to set a registering destination to the biometric device by carrying out complex operations of the biometric device. However, according to the arrangement, setting of such registering destination can be easily carried out to the biometric device.

The setting device preferably includes a wireless communication unit for carrying out wireless communication with the biometric device, the setting information output section transmitting at least one of the setting contents to the biometric device via the wireless communication unit.

According to the arrangement, it is possible to eliminate any special operations carried out when setting the biometric device, such as having the setting device have contact with the biometric device, or connecting the setting device and the biometric device with a cable.

The setting device preferably has a wireless communication unit for carrying out wireless communication with the biometric device, the notification section receiving the measurement result from the biometric device via the wireless communication unit.

According to the arrangement, it is possible to eliminate any special operations carried out when the user causes the setting device to notify the measurement result, such as having the setting device have contact with the biometric device, and connecting the setting device and the biometric device with a cable.

The device information acquisition section may acquire the device information from the biometric device. Alternatively, the setting device may further include an operation entering unit, the device information acquisition section acquiring the device information via the operation entering unit.

Moreover, the setting device may be a mobile phone.

Currently, mobile phones are particularly high in diffusion rate, and are a device that is rather held at all times. Therefore, by having the mobile phone have a setting function of the biometric device, it is possible to provide a user with a comfortable usage environment of the biometric device, without a need for the user to hold a further device.

In order to attain the object, a biometric device according to the present invention is a biometric device for measuring biometric information, including: a device information notification section for notifying device information to an external device, the device information being information related to the biometrics device; a setting content acquisition section for acquiring a setting content that is returned in accordance with the device information notified by the device information notification section; and a setting section for carrying out a setting based on the setting content acquired by the setting content acquisition section.

According to the arrangement, the device information notification section notifies device information to a setting device. Setting content that is returned from the setting device is acquired by the setting content acquisition section, in order for a setting section to carry out a setting based on the setting content. Therefore, it is possible to eliminate a need to carry out complex operations required for setting a biometric device at a time when a user is to use the biometric device. Even in a case where a multiple number of users share the biometric device, there is no need for the users to carry out the setting of complex operations every time the biometric device is to be used. As the above, according to the present invention, various settings of a biometric device can be easily carried out without the user having to carry out any complex operations to the biometric device.

The setting device and biometric device may be realized by hardware, or may be realized by causing a computer to carry out a program. More specifically, a program according to the present invention is a program for causing a computer to function as each of the sections of a setting device or a biometric device, and a recording medium according to the present invention records the program.

Execution of the program on a computer causes the computer to function as the setting device or the biometric device. Therefore, various settings of the biometric device are easily carried out.

For a fuller understanding of the nature and advantages of the invention, reference should be made to the ensuing detailed description taken in conjunction with the accompanying drawings.

### BRIEF DESCRIPTION OF DRAWINGS

FIG. 1 illustrates one embodiment of the present invention, and is a functional block diagram illustrating an arrangement of a setting device.

FIG. 2 illustrates one embodiment of the present invention, and is an explanatory view illustrating an overall arrangement of a setting system of a biometric device.

FIG. 3 illustrates one embodiment of the present invention, and is a functional block diagram illustrating an arrangement of a biometric device.

FIG. 4 illustrates one embodiment of the present invention, and is a flow chart illustrating measurement/diagnosis procedures to be carried out by a biometric device.

FIG. 5 illustrates one embodiment of the present invention, and is an explanatory view illustrating one example of a user information database.

FIG. 6 illustrates one embodiment of the present invention, and is an explanatory view illustrating one example of a time limit information table.

FIG. 7 illustrates one embodiment of the present invention, and is an explanatory view illustrating one example of an in-home device table.

FIG. 8 illustrates one embodiment of the present invention, and is an explanatory view illustrating one example of an output mode table.

FIG. 9 illustrates one embodiment of the present invention, and is an explanatory view illustrating one example of a setting information output safety degree table.

FIG. 10 illustrates one embodiment of the present invention, and is an explanatory view illustrating one example of a device setting item table.

FIG. 11 illustrates one embodiment of the present invention, and is an explanatory view illustrating one example of registering destination information.

FIG. 12 illustrates one embodiment of the present invention, and is a flow chart illustrating setting procedures of a biometric device by use of a setting device.

FIG. 13 illustrates one embodiment of the present invention, and is a flow chart illustrating detail procedures of S111 in FIG. 12.

FIG. 14 illustrates one embodiment of the present invention, and is an explanatory view illustrating one example of an inquiry screen to be displayed to a user by the notification section 25, in a case where a safety degree of an output mode is not higher than a confidentiality degree of user information.

FIG. 15 illustrates one embodiment of the present invention, and is an explanatory view illustrating one example of an inquiry screen to be displayed to a user by a notification section, in a case where user information has exceeded a validity limit.

FIG. 16 illustrates one embodiment of the present invention, and is a flow chart illustrating detail procedures of S113 in FIG. 12.

FIG. 17 illustrates one embodiment of the present invention, and is an explanatory view illustrating one example of an inquiry screen to be displayed to a user by a notification section, in a case where there are no output modes that have higher safety degrees than confidentiality degrees, respectively.

FIG. 18 illustrates one embodiment of the present invention, and is an explanatory view illustrating one example of an inquiry screen to be displayed to a user by a notification section in a case where there are a plurality of output modes that have higher safety degrees than confidentiality degrees, respectively.

FIG. 19 illustrates one embodiment of the present invention, and is a flow chart illustrating updating procedures of user information stored in a user information database.

FIG. 20 illustrates one embodiment of the present invention, and is a flow chart illustrating procedures for storing a measurement result acquired from a biometric device to a user information database as user information.

### REFERENCE NUMERALS

1 pulse rate measuring device (biometric device)
2 pace measuring device (biometric device)
3 blood pressure measuring device (biometric device)
4 body temperature measuring device (biometric device)
5 body fat measuring device (biometric device)
6 glycosuria measuring device (biometric device)
7 setting device
13 body fat measuring device (biometric device)
21 operation entering unit
22 communication unit
23 setting request acquisition section (device information acquisition section)
25 notification section
26 setting information output section
27 setting information management section
27a user information management section
27b output mode information management section
30 storage section (setting information storage section, confidentiality degree storage section, setting item storage section, validity period storage section)
31 user information database
32 time limit information table
33 in-home device table
34 output mode table
35 setting information output safety degree table
36 device setting item table
37 registering destination information
100 setting system
101 biometric device
104 setting request notification section (device information notification section)
105 result output section
106 communication unit
108 setting content acquisition section (setting section)
109 user information storage section
110 output setting storage section

### BEST MODE FOR CARRYING OUT THE INVENTION

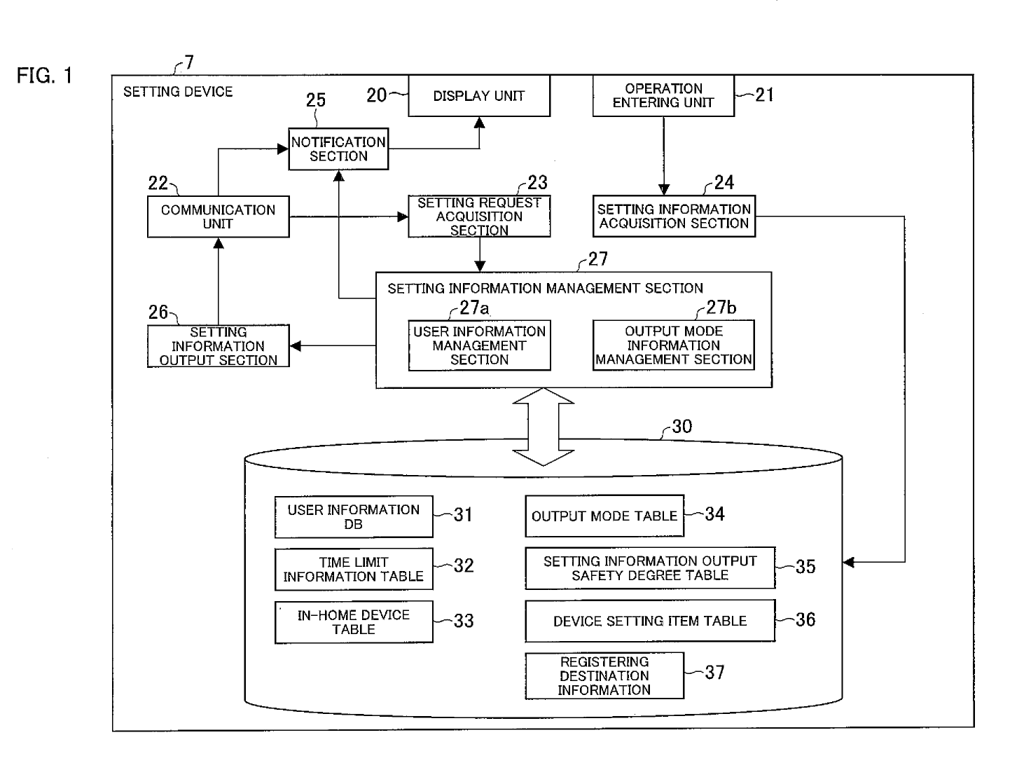

One embodiment of the present invention is described below with reference to FIGS. 1 through 20. In the following description, identical reference numerals are given for identical components which have identical names and functions. Therefore, detail explanations of these components are not repeatedly given.

(System Outline)

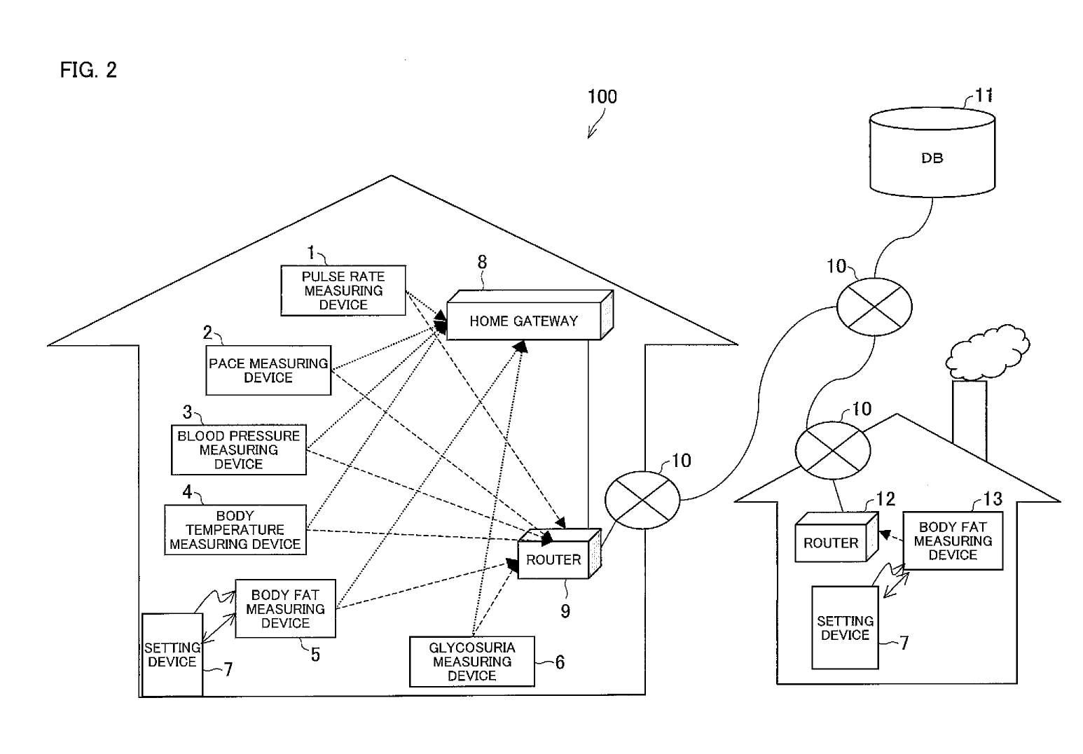

FIG. 2 illustrates one embodiment of the present invention, and is an explanatory view illustrating an overall arrangement of a setting system 100 of a biometric device (hereinafter referred to simply as “setting system”). As illustrated in FIG. 2, the setting system 100 includes a plurality of biometric devices 1 through 6 and 13, setting devices 7•7, a home gateway 8, routers 9 and 12, a database 11, and the like. Each of the devices included in the setting system 100 is capable of carrying out communication via a communication network.

The biometric devices 1 . . . measure various biometric information of a user, and the present embodiment includes a pulse rate measuring device 1, a pace measuring device 2, a blood pressure measuring device 3, a body temperature measuring device 4, a body fat measuring device 5, a glycosuria measuring device 6 and the like. Some of the biometric devices 1 . . . are capable of carrying out measurement and diagnosis of biometric information once physical and/or personal information of the user is entered, or can carry out more accurate measurement and diagnosis of biometric information in response to the entering of the physical and/or personal information.

For example, assume that the user owns the pulse rate measuring device 1 for dietary purposes. The pulse rate measuring device 1 calculates a heart rate called “target heart rate”, so as to cause the user to exercise having this heart rate as a standard. Thus, it is possible to expect an effect of maintaining an exercise intensity desired by the user, without giving any excess burden on a body of the user. That is, the user constantly wears the pulse rate measuring device 1 while exercising so as to cause the pulse rate measuring device 1 to measure a pulse rate of the user, and exercises by utilizing the target heart rate as a standard. Thus, it is possible for the user to work on a diet without giving burden on the body.

In a case where the target heart rate is calculated by the pulse rate measuring device 1, the user (i) wears the pulse rate measuring device 1 at rest before starting to exercise, (ii) enters, to the pulse rate measuring device 1, “target exercise intensity (strength of exercise)” and “age” of the user, and (iii) measures the heart rate with the pulse rate measuring device 1. The pulse rate measuring device 1, in response to this, calculates the target heart rate based on a measurement result and the information thus entered.

In comparison, in a case where a body fat ratio is measured by the body fat measuring device 5, a user enters “age”, “sex” and “height” before measurement. Following this, the user measures its weight and current resistance with the body fat measuring device 5. In response to this, the body fat measuring device calculates a body fat ratio based on the measured values and the values thus entered. In a case of the pace measuring device 2, entering of weight allows calculation of consumed calories in accordance with a measured number of paces.

Of course, items to be entered to the biometric devices and items that are measurable by the biometric devices are not limited to the above. For example, in the case of the pace measuring device 2, “age” and “sex” may further be entered so as to calculate the consumed calories more accurately. The pace measuring device 2 may also measure a walking speed. Of course, the biometric devices are not limited to the aforementioned devices, and may include various types of devices from simple devices such as a weight scale and a height measure to advanced medical devices such as CT (Computed Tomography) devices and MRI (Magnetic Resonance Imaging) devices.

As such, the biometric devices included in the setting system 100 have predetermined personal and/or physical information entered in advance, so as to find and carry out diagnosis of various biometric information based on the information entered and results measured. A user owns and uses a plurality of such biometric devices for health care purposes such as management of physical condition of oneself or a family thereof, and in-home medical care services.

The setting devices 7 carry out various settings of the biometric devices 1 . . . . More specifically, the setting devices 7 store setting information that are required in the various biometric devices 1 . . . in advance, and when a setting request is received from respective one of the biometric devices 1 . . . , corresponding setting information is read out from the storage section, and at least one of setting contents indicated by the setting information is notified to the corresponding one of the biometric devices 1 . . . .

The physical and/or personal information of a user is a first example of the setting information of the biometric devices to be stored in the setting devices 7 in advance. The setting devices 7 store, as a database, the physical and personal information of a user that is required in order for the biometric devices 1 . . . to measure and carry out diagnosis. When the setting devices 7 acquire information related to a corresponding one of the biometric devices 1 from device information received together with the setting request, the physical and/or personal information which is required by the corresponding one of the biometric devices 1 that sent the setting request is selected and read out from the database. Subsequently this physical and/or personal information is notified to the corresponding one of the biometric devices 1 . . . . That is to say, the setting devices 7 centrally manage the physical and personal information of the user, different to the technique of Patent Document 1. Therefore, there is no need to repeatedly enter identical setting information to each corresponding biometric device at the time when entering or updating the physical and/or personal information in the database of the setting devices 7. As a result, it is possible to remarkably reduce trouble caused to the user.

The setting information stored by the setting devices 7 is not limited to the foregoing physical and/or personal information of the user. For example, in the present embodiment, the setting devices 7 also have display sections for displaying measurement and diagnosis results obtained by the biometric devices 1 . . . . Accordingly, it is possible to carry out a setting for specifying output modes of whether the measurement and diagnosis results are to be displayed on the corresponding one of the biometric devices 1 . . . or on the display section of a corresponding setting device 7.

In a case where the measurement and diagnosis results of the biometric devices 1 . . . are desirably stored in the home gateway 8 and the database 11 on the Internet 10, settings of a registering destination may be made to the setting devices 7 with respect to a corresponding biometric device. Daily biometric information such as blood pressure, body temperature, and glycosuria, each of which are measured by use of the in-house biometric device 1, can be collectively managed in the home gateway 8 or the database 11 on the Internet by registering the measurement and diagnosis results obtained by corresponding ones of the biometric devices 1 . . . to a storage device via the communication network. As a result, it is possible to receive health care services provided via a communication network such as telemedicine services.

Moreover, the home gateway 8 and the database 11 on the Internet 10 may store not just the measurement results of the biometric devices 1 . . . in-home, but also measurement results of biometric devices that are located outside, such as the body fat measuring device 13. This allows storage of results measured at an external facility such as a public bath, sports gym, or beauty care salon. Consequently, thorough management of one's own biometric information is possible.

As described above, just by owning one setting device 7, a user can register one's physical and personal information to various biometric devices, and carry out settings of output modes of measurement and diagnosis results, respectively. As a result, various biometric devices are easily set.

It is preferable for the setting devices 7 to be easily carried by a user at all times, and for example, is preferably incorporated into a mobile phone. Currently, mobile phones are particularly high in diffusion rate, and are a device that is rather held at all times. Therefore, by having the mobile phone have a setting function of the biometric devices 1 . . . , it is possible to provide a user with a comfortable usage environment of the biometric devices 1 . . . , without a need for the user to hold a further device. Note that conventional techniques are usable as to functions inherent to the mobile phone. Therefore, explanation of these is omitted here.

(Biometric Device)

The following description explains arrangements of the biometric devices 1 through 6, and 13. Here, descriptions of arrangements that are common to all of the biometric devices are given, and arrangements that are inherent to each of the biometric devices such as various measuring mechanisms of biometric information are to be the same as conventional ones, and explanations of these are omitted. Note that in the following description, devices for measuring a living body according to the present invention including the biometric devices 1 through 6 and 13 are referred to as biometric device 101 as a whole.

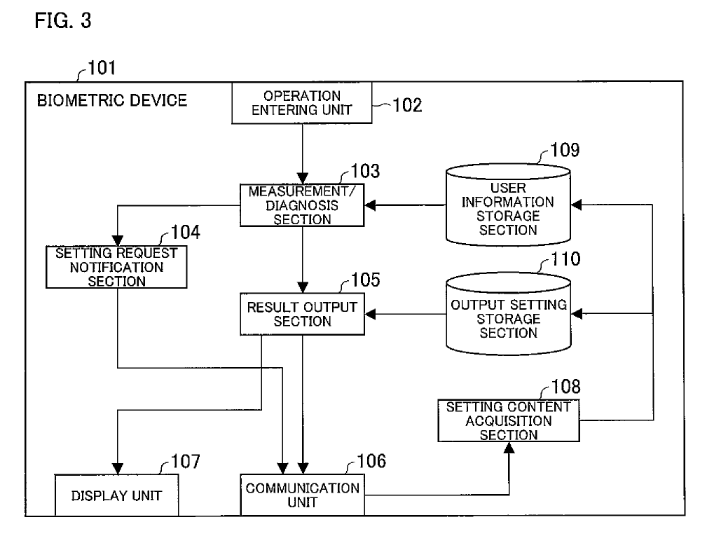

FIG. 3 illustrates one embodiment of the present invention, and is a functional block diagram illustrating an arrangement of a biometric device 101. The biometric device 101 includes, as illustrated in FIG. 3, an operation entering unit 102, a measurement/diagnosis section 103, a setting request notification section 104, a result output section 105, a communication unit 106, a display unit 107, a setting content acquisition section 108, a user information storage section 109, and an output setting storage section 110.

The operation entering unit 102 is a user interface for entering instructions and information to the biometric device 101 by operation of a user, and has a plurality of buttons, for example. The display unit 107 notifies the user by sight of various information such as measurement and diagnosis results (hereinafter referred to together as “measurement result”), and has, for example, a liquid crystal panel. The communication unit 106 is a hardware device for carrying out communication with a setting device 7, a home gateway 8, a router 9, an Internet 10 and the like. The communication unit 106 is preferably a Bluetooth (registered trademark) unit that is communicable in close distance wireless communication, or a wireless communication unit communicable by wireless communication regulated in IEEE802.11. Therefore, there are no restrictions by wiring in providing the biometric device 101.

The user information storage section 109 includes a flash memory and the like, and stores personal and physical information of a user (hereinafter referred to together as “user information”) required for measurement and diagnosis. Moreover, the output setting storage section 110 similarly includes a flash memory and the like, and stores setting information indicative of an output mode of the measurement and diagnosis result to be outputted by the result output section 105.

The measurement/diagnosis section 103 measures and/or operates the foregoing various biometric information, and carries out diagnosis of the user if necessary. Specific arrangements of the measurement/diagnosis section 103 depend on a kind of biometric information that is to be measured by the biometric device 101, however the arrangement is basically same as that of a conventional one. When biometric information of a user is measured, the measurement/diagnosis section 103, as described above, finds and carries out diagnosis of a target biometric information based on (i) a measured value by a measuring mechanism not illustrated, and (ii) user information read from the user information storage section 109.

The setting request notification section 104 notifies the setting device 7 of a setting request in response to an order from the measurement/diagnosis section 103. More specifically, the communication unit 106 is controlled so that the setting request is transmitted to the setting device 7 via a communication network. A timing in which the measurement/diagnosis section 103 orders the setting request notification section 104 to transmit the setting request is, for example, when a user instructs, via the operation entering unit 102, carrying out of measurement of biometric information and/or diagnosis based on a measurement result.

The setting request notification section 104 also carries out transmission of device information for specifying the biometric device 101. The device information can be included in the setting request. The device information is, more specifically, a device ID of the biometric device 101 (serial number, network address, model number and the like), and a type ID for specifying a name, type and category of at least one measurement item which is to be measured by the biometric device 101.

Following the notification of the setting request to the setting device 7 by the setting request notification section 104, the setting content acquisition section 108 acquires setting content to be notified by the setting device 7. More specifically, the setting content acquisition section 108 controls the communication unit 106 so as to receive the setting content from the setting device 7 via the communication network. Thereafter, if the setting content received is indicative of user information, the setting content acquisition section 108 stores the user information corresponding to the setting content in the user information storage section, and if the setting content received specifies an output mode of a measurement result, the setting content acquisition section 108 stores output setting information corresponding to the setting content in the output setting storage section 110.

The result output section 105 outputs at least one measurement result found by the measurement/diagnosis section 103. A plurality of modes are selectable in the result output section 105 as modes for outputting the measurement result, for example: (a) controlling the display unit 107 so that the measurement result is directly displayed on the display unit 107; (b) controlling the communication unit 106 so that the measurement result is transmitted to the setting device 7 to be displayed on the display unit of the setting device 7; and (c) controlling the communication unit 106 so that the measurement result is transmitted and registered to the home gateway 8 and database 11. In a case where the transmission of the measurement result is carried out in methods (b) or (c), it is also selectable whether or not to encode the data to be transmitted. The result output section 105 selects the output modes based on the setting information stored in the output setting storage section 110.

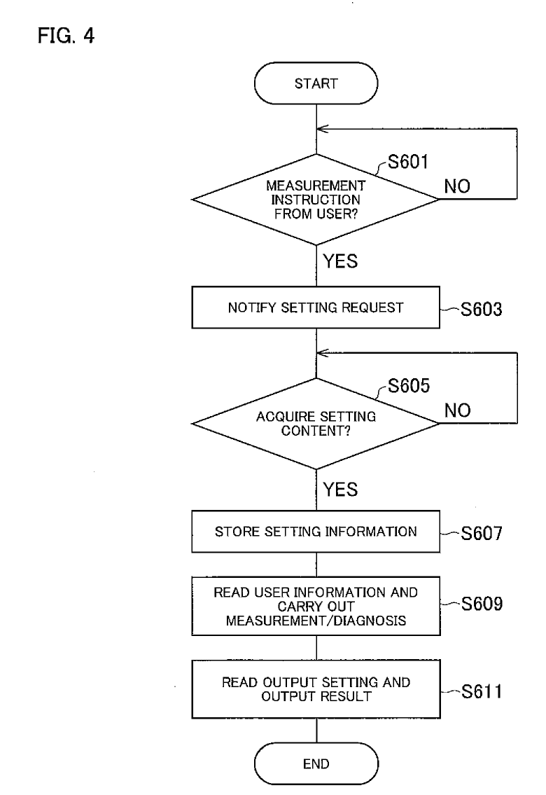

The following description explains procedures of the biometric device 101. FIG. 4 illustrates one embodiment of the present invention, and is a flow chart illustrating measurement/diagnosis procedures carried out by the biometric device 101.

As illustrated in FIG. 4, the measurement/diagnosis section 103 determines whether or not a measurement instruction is received from a user via an operation entering unit 102 (S601). In a case where the measurement instruction is not received, the measurement/diagnosis system standbys until the measurement instruction is received.

On the other hand, in a case where the measurement instruction is received, the measurement/diagnosis section 103 instructs the setting request notification section 104 to transmit a setting request. In response, the setting request notification section 104 controls the communication unit 106 so as to transmit the setting request, device ID and type ID to the setting device 7 (S603).

Following this, the setting content acquisition section 108 controls the communication unit 106, and standbys until the setting content is received from the setting device 7 (S605). When the setting content is received, the setting content acquisition section 108 stores the user information to the user information storage section 109, and stores the output setting information to the output setting storage section 110 (S607). Note that the user information and the output setting information are both indicative of the setting content.

Next, the measurement/diagnosis section 103 reads the user information required to carry out measurement/diagnosis from the user information storage section 109. The measurement/diagnosis section 103 then carries out measurement of the user by use of a measuring mechanism not illustrated, so as to find a target biometric information and carry out diagnosis of the user, based on the user information read and the value measured (S609). Accordingly, the measurement/diagnosis section 103 notifies the result output section 105 of an attained measurement result.

The result output section 105 reads output setting information from the output setting storage section 110 which output setting information specifies an output mode, so as to output a measurement result received from the measurement/diagnosis section 103 in the output mode indicated by the output setting information (any one or a combination of the aforementioned (a) through (c)) (S611). This completes the measurement/diagnosis process.

As above, according to the biometric device 101 of the present embodiment, a setting request is transmitted to the setting device 7 before carrying out the measurement/diagnosis of the user in order for the biometric device 101 to carry out measurement based on user information that is returned from the setting device 7. This allows measurement and diagnosis of various biometric information in a condition suitable for each individual. Furthermore, according to the biometric device 101 of the present embodiment, a mode for outputting the measurement result is also set based on the setting information transmitted from the setting device 7. Therefore, the measurement result can be outputted in a mode suitable for the individual. Moreover, according to the biometric device 101 of the present embodiment, at the time when the setting is carried out, settings of the user information and the output mode are carried out based on the setting information acquired from the setting device 7. Therefore, there is no need for the user to manually enter any setting information by use of the operation entering unit 102 or the like. Thus, various settings can be carried out easily.

(Arrangement of Setting Device)

The following description is a detail explanation of an arrangement of a setting device 7 for setting the biometric device 101. FIG. 1 illustrates one embodiment of the present invention, and is a functional block diagram illustrating the arrangement of the setting device 7. The setting device 7 includes a display unit 20, an operation entering unit 21, and a communication unit 22, as illustrated in FIG. 1.

The display unit 20 visually notifies a user of various information such as an operation instruction, a measurement result received from the biometric device 101, and the like, and has, for example, a liquid crystal panel. The operation entering unit 102 is a user interface for entering instructions and information to the biometric device 101 by operations of the user, and has, for example, a plurality of buttons. The communication unit 22 is a hardware device for carrying out communication with the biometric device 101. Although the communication unit 22 can be either wireless or lined communication, the communication unit 22 is preferably a Bluetooth (registered trademark) unit or a wireless communication unit capable of wireless communication regulated in IEEE802.11, or the like.

The communication unit 22 is also made communicable with the home gateway 8 and the database 11 on the Internet 10, not just the communication with the biometric device 101. This thus allows the setting device 7 to be used as a relay device which outputs, when a measurement result is received from the biometric device 101, the measurement result to the home gateway 8 and database 11. A method of receiving the measurement result from the biometric device 101 is later described; the explanation thereof is omitted here.

The setting device 7 further includes, as illustrated in FIG. 1, a setting request acquisition section 23, a setting information acquisition section 24, a notification section 25, a setting information output section 26, a setting information management section 27, and a storage section 30. The storage section 30 includes a flash memory and the like, and stores a user information database 31, a time limit information table 32, an in-home device table 33, an output mode table 34, a setting information output safety degree table 35, a device setting item table 36, registering destination information 37, and the like.

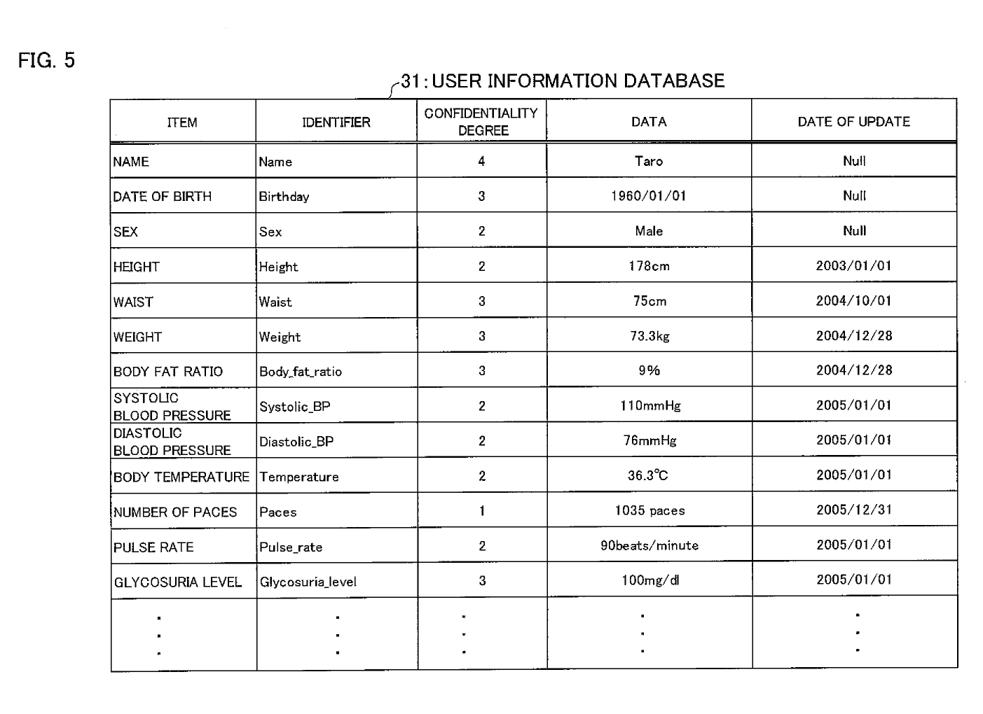

FIG. 5 illustrates one embodiment of the present invention, and is an explanatory view illustrating one example of a user information database 31. The user information database (hereinafter referred to as “user information DB”) 31 includes personal and physical information of a user who is to use the biometric device 101, as illustrated in FIG. 5. More specifically, the user information DB 31 contains: personal information including a plurality of items such as name, date of birth and sex; and physical information including a plurality of items such as height, waist, weight, body fat ratio, systolic blood pressure, diastolic blood pressure, body temperature, number of paces, pulse rate and glycosuria level. In the following description, the personal and physical information may be referred to as user information together as one. Note that, as illustrated in FIG. 5, the user information (information in the column that is indicated as “data” in FIG. 5) corresponds to identifiers, respectively, which identifiers specify content of each item in the user information DB 31.

In the user information DR 31, the user information corresponds to confidentiality degrees indicative of degrees of confidentiality of the user information, respectively. The confidentiality degrees indicate how private that user information corresponding to the confidentiality degree is, in other words, how embarrassing the user information corresponding to the confidentiality degree is for the user, or how much the user does not want the information to be known by others. In the present embodiment, the confidentiality degrees are expressed by integral values of 1 through 5, and the larger the value the more private the information is of the user information. As illustrated in FIG. 5, information such as the name, waist, and weight for example are information which are desirably not known by others, therefore the confidentiality degrees are relatively large in value. In comparison, height has the confidentiality degree of 2 points; it is obvious that the information has a slightly low confidentiality degree.

In the user information DB 31, the physical information corresponds to dates at which the information are prepared or updated, respectively. This date indicates a freshness of data. For example, in a case of height, data “178 cm” corresponds to the date of “Jan. 1, 2003”. Therefore, it is clear that this value of 178 cm was measured on Jan. 1, 2003. On the other hand, personal information such as the name, date of birth, sex and the like do not correspond to the date; a value “Null” corresponds to such information. This is because the personal information such as the name, date of birth, sex and the like are invariant data that basically do not change, and is considered as not having much sense in having the date. Note that in the present embodiment, although just a date is used as information for indicating an updating period, time information may also be added thereto.

As the above, the setting device 7 handles the user information as one of invariant data and variable data; variable data corresponds to update information, and invariant data corresponds to the value “Null”. In other words, data of the user information that corresponds to the update information indicates that the user information is of the variable data, and data of the user information that corresponds to the value “Null” indicates that the personal or physical information is of the invariant data. Therefore, it is clear in the user information DB 31 that the name, date of birth, and sex are data that have invariant elements which are not influenced by time.

In the user information DB 31, user information is registered and updated in advance by a user or a person who has obtained permission from the user. Moreover, among the user information, the physical information can be automatically updated by use of the measurement result of the biometric device 101.

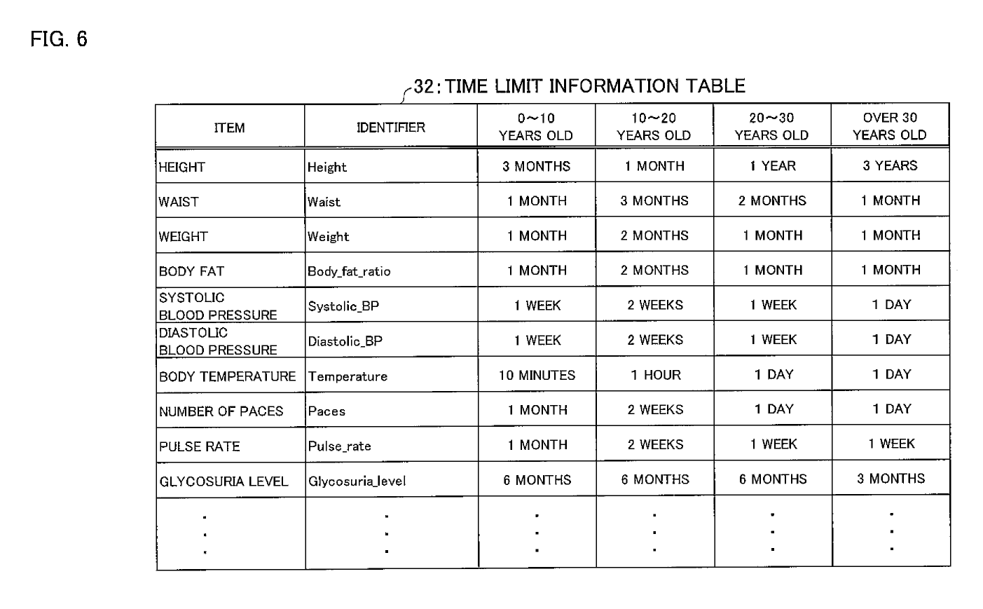

FIG. 6 illustrates one embodiment of the present invention, and is an explanatory view illustrating one example of the time limit information table 32. The time limit information table 32 indicates validity periods for the user information that are stored in the user information DB 31, respectively. In this time limit information table 32, as illustrated in FIG. 6, the validity period of the physical information correspond to identifiers of the physical information, respectively. Values that are common to the identifiers in the user information DB 31 of FIG. 5 are used as the values in the time limit information table 32.

The present embodiment indicates the validity periods of the physical information per age group. The validity periods correspond to the identifiers of the physical information and the age group, respectively. For example, the measurement result of height is valid for 3 months for the age group of not less than 0 years old to less than 10 years old, 1 month for the age group of not less than 10 years old to less than 20 years old, 1 year for the age group of not less than 20 years old to less than 30 years old, and 3 years for the age group of not less than 30 years old. The validity periods of the information is set by age group due to unevenness in change of the physical information, and that it is difficult to uniformly maintain the freshness during a same validity period. Note that a definition of freshness is not limited to this. This time limit information table 32 is prepared in advance.

In the user information DR 31, the user information corresponds to identification information of items, respectively. In the time limit information table 32, the identification information of the items corresponds to the validity periods, respectively. Therefore, it is interpretable that the user information is corresponded to the validity period, in the storage section 30. Such interpretation of corresponding of information is also possible for other information. The explanation of those is omitted in the following description.

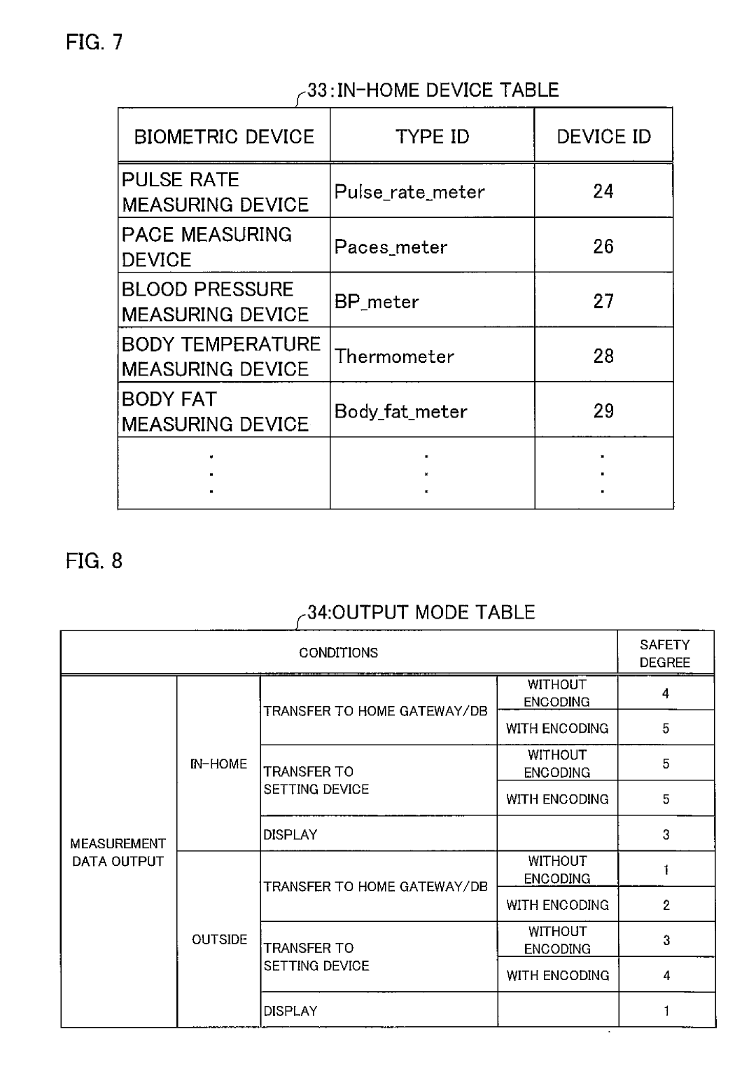

FIG. 7 illustrates one embodiment of the present invention, and illustrates one example of the in-home device table 33. The in-home device table 33 indicates what type of biometric device is provided in a home of a user. For example in FIG. 2, biometric devices that are placed in a home are the pulse rate measuring device 1, a pace measuring device 2, a blood pressure measuring device 3, a body temperature measuring device 4, a body fat measuring device 5 and a glycosuria measuring device 6, as an example. The in-home device table 33 includes device IDs that are unique identification information of each of the biometric devices 101 provided in the home, respectively. Further, in the in-home device table 33, the device IDs correspond to type IDs, respectively, which type ID indicates a type (category) of the biometric device having the corresponding device ID. The type IDs are determined based on (i) the physical information measurable by each of the biometric devices 101 and (ii) the items of the physical information required for the measurement and diagnosis, respectively. Therefore, devices that measure same physical information by use of identical physical information have identical type IDs. The information of the biometric device 101 to be registered in the in-home device table 33 is automatically updated at the time when the user purchases a biometric device 101. By thus referring to the in-home device table 33, it is possible to obtain the type ID indicative of a category (type) of the biometric device 101 from the device ID included in the device information.

FIG. 8 illustrates one embodiment of the present invention, and is an explanatory view illustrating one example of an output mode table 34. The output mode table 34 is information indicating output modes of measurement results obtained by measuring a user by the biometric device 101, and includes information of a plurality of different output modes. In the present embodiment, largely two kinds of the output modes can be selected as the output modes of the results obtained by the biometric device 101: (i) transferring the results to an in-home device, or displaying the results on an in-home biometric device 101, or (ii) transferring the results to a device outside of the home, or displaying the results on a biometric device 101 outside of the home. Further, the following output modes are further selected in the in-home or outside thus selected: (a) transferring the results to the home gateway 8 or the database 11 to register the result therein; (b) transferring the results to the setting device 7 to display the results on the display unit 20 of the setting device 7; or (c) displaying the result on the display unit 107 of the relevant biometric device 101. Moreover, in cases where the result is to be transferred to the home gateway 8/database 11 or the setting device 7, whether or not the data to be transferred is encoded is further selected.

In FIG. 8, for example “transfer to home gateway/DB” denotes an output mode of “transferring”, to the home gateway 8 or the database 11 on the Internet, at least one measurement result obtained by measuring biometric information by the biometric devices 1 through 5 located in-home, or obtained by the various biometric devices 101 located outside of the home, illustrated in FIG. 2.

As from the above, ten output modes are available for selection in the present embodiment. The ten output modes each correspond to a safety degree indicative of a degree of safety of the output modes, respectively. The safety degrees numerically express whether the output modes corresponding to the safety degrees are safe or not, and are evaluated into five stages (integral values of 1 through 5); a higher value denotes a more safe and safely used output mode. Here, it is defined such that: the in-home has a higher safety degree than the outside of the home; an encoded result has a higher safety degree than a result that is not encoded; and a transfer to the setting device 7 has a higher safety degree than a transfer to the gateway 8. Note that a definition of the output mode is not limited to this. For example, an output mode that notifies a user of the measurement and diagnosis result by audio may further be added, or an output mode may be defined for each terminal of the transferred device. This output mode table 34 is prepared in advance before the use of the setting device 7.

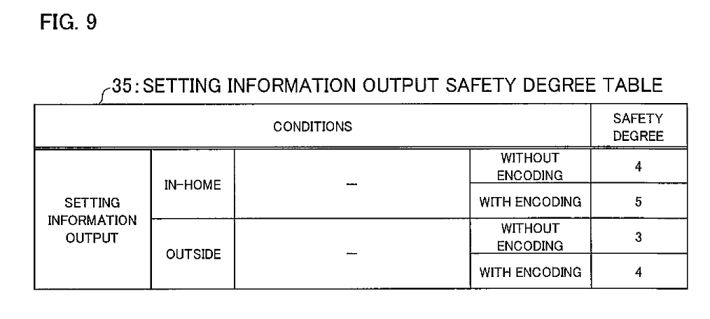

FIG. 9 illustrates one embodiment of the present invention, and is an explanatory view illustrating one example of a setting information output safety degree table 35. The setting information output safety degree table 35 indicates safety degrees for notification modes, respectively, when the setting device 7 notifies the user information to the biometric device 101. The kinds of notification modes are largely divided into two modes as illustrated in FIG. 9: a case where user information is transmitted from the setting device 7 to the biometric device 101 in-home, and a case where user information is transmitted to the biometric device 101 outside of the home. The two modes are further divided into a further two modes, by whether or not the result is encoded. Therefore, in the present embodiment, four kinds of output modes are assumable. The present embodiment is defined such that the in-home is higher in safety degree as compared to the outside of the home, and an encoded result has a higher safety degree as compared a result not encoded. The setting information safety degree cable 35 is prepared in advance before the setting device 7 is used.

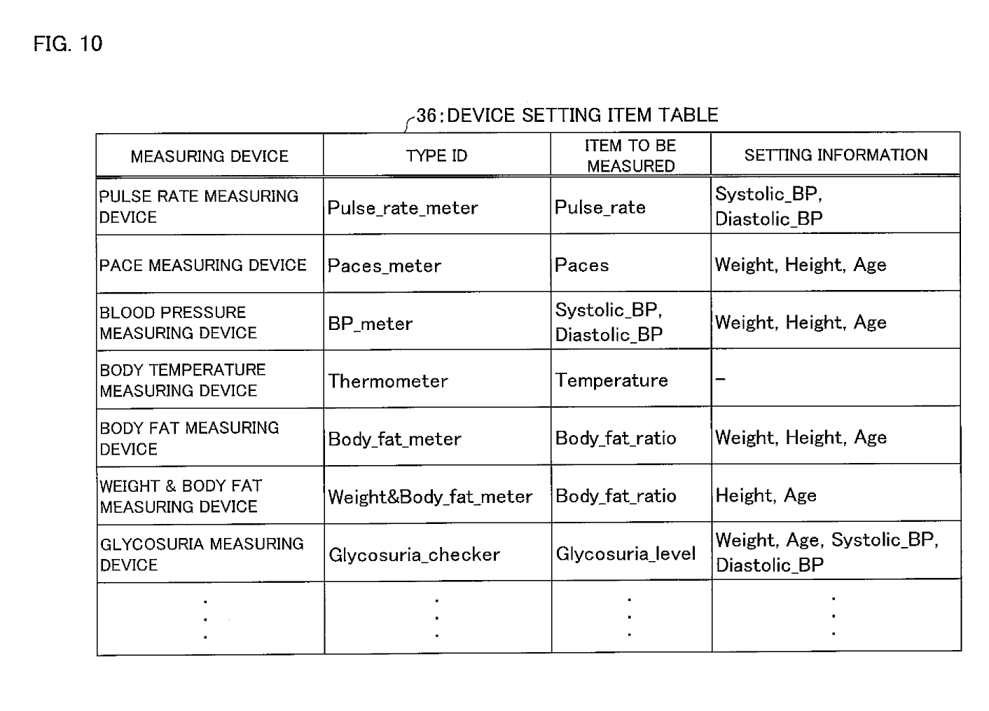

FIG. 10 illustrates one embodiment of the present invention, and is an explanatory view illustrating one example of a device setting item table 36. As illustrated in FIG. 10, the device setting item table 36 stores (i) type IDs indicative of types of the biometric device 101, (ii) identification information of items of physical information that are objected to measurement, and (iii) identification information of items of user information which require to be set at the time of measurement. The type IDs, the identification information of items of physical information and the identification information of items of user information are stored so as to correspond to each other. The values of the type IDs used in the in-home device table 33 illustrated in FIG. 7 are used as values of the type IDs stored in the device setting item table 36, and the values of the identifiers used in the user information DB 31 illustrated in FIG. 5 are used as values of the identification information of items to be measured and the identification information of items which require a setting. The device setting item table 36 is prepared in advance, before use of the setting device 7. By referring to the device setting item table 36 and the in-home device table 33 illustrated in FIG. 7, it is possible to specify a type of the user information that requires to be set at a time of measurement by a respective biometric device 101, from the device IDs included in the device information.

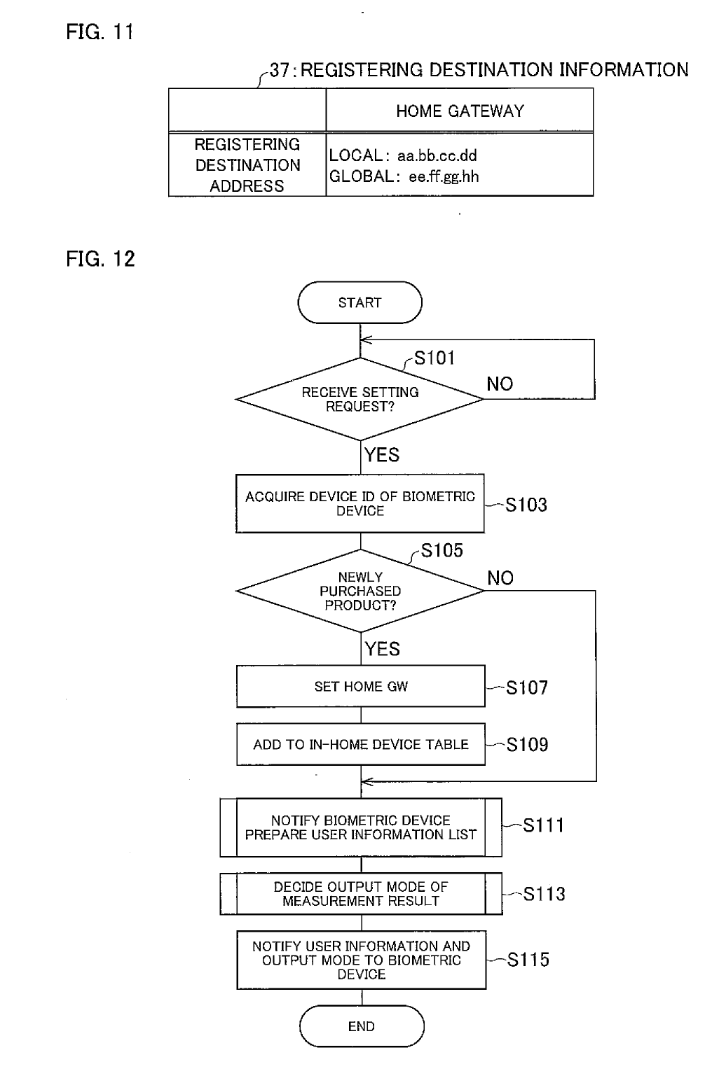

FIG. 11 illustrates one embodiment of the present invention, and is an explanatory view illustrating one example of registering destination information 37. In the present embodiment, the registering destination information 37 includes IP addresses of communication devices that are to register the measurement result measured by the biometric device 101 (for example the home gateway 8 or database 11). The registering destination information 37 is prepared by a user or a person who has obtained permission from the user.

The setting request acquisition section 23 acquires, from a biometric device 101, a setting request, and device information including the device ID and type ID of the biometric device 101. More specifically, the setting request acquisition section 23 controls the communication unit 22 so as to receive the setting request, device ID and type information, each of which is transmitted from the biometric device 101. The device ID transmitted from the biometric device 101 is unique thereto, and is identical to the device ID indicated in the in-home device table 33 of FIG. 7. On the other hand, the type IDs transmitted from the biometric device 101 arc indicative of types of the biometric device 101, and are common to the type IDs indicated in the in-home device table 33 and the device setting item table 36.

The setting information acquisition section 24 acquires user information to be registered in the user information DB 31, and acquires information entered by the user via the operation entering unit 21.

The notification section 25 notifies various information to the user. In the present embodiments the notification section 25 notifies information to the user by controlling the display unit 20 so that the display unit 20 displays various messages. However, the present invention is not limited to this form, and notification may be carried out for example by audio.

The notification section 25 has functions such as: (a) asking a user whether or not user information selected by the setting information management section 27 is to be notified to the respective biometric device 101, (b) asking the user which output mode is to be used in a case where a plurality of output modes are selected by the setting information management section 27, (c) controlling the communication unit 22 so as to receive a measurement result from the biometric device 101, and displaying the measurement result on the display unit 20, and (d) in a case where the user information stored in the user information DB 31 has expired in its validity limit, displaying a message on the display unit 20 so as to request for a data update. More details are later described.

The setting information output section 26 notifies, to the biometric device 101, at least one of setting contents indicated by the setting information stored in the storage section 30, in accordance with the setting request acquired by the setting request acquisition section 23. More specifically, (i) the user information read out from the user information DB 31 by the setting information management section 27 and (ii) the output mode information read out from the output mode table 34 by the setting information management section 27 are received from the setting information management section 27, and the communication unit 22 is controlled so that the setting information output section 26 transmits, to the biometric device 101, at least one of the setting contents indicated by the setting information thus received.

Moreover, in the present embodiment, the output mode of the measurement result measured by the biometric device 101 is changeable for each item. Therefore, the setting information output section 26 notifies, to the biometric device 101, the output mode for each of the measurement and diagnosis item.

The setting information management section 27, in accordance with the setting request acquired by the setting request acquisition section 23, reads out (i) user information from the user information DB 31 and (ii) output mode information from the output mode table 34, which output mode information indicates an output mode of a respective measurement result, so as to notify the information thus read out to the setting information output section 26. The setting information management section 27 has, more specifically, a user information management section 27a that reads out user information from the user information DB 31, and an output mode information management section 27b that reads out the output mode information from the output mode table 34.

The user information management section 27a (i) specifies the category (type) of the biometric device 101 that has transmitted the setting request, based on the device information such as the device ID and type ID received by the setting request acquisition section 23, and (ii) selects, from the user information DB 31 of the storage section 30, the user information required by the biometric device 101 which has sent the setting request. Moreover, the user information management section 27a compares, for the user information thus selected, a confidentiality degree corresponding to the user information and a safety degree corresponding to the output mode of the setting information output section 26. As a result of comparison, the user information that has a higher safety degree than the confidentiality degree is further selected from the user information DB 31 so as to be read out. On the other hand, in a case where the user information has a lower safety degree than the confidentiality degrees, the notification section 25 asks the user whether or not the user information is to be outputted, so as to determine whether or not to read out the user information from the user information DB 31 based on instructions of the user.

On the other hand, the output mode information management section 27b selects and reads out, from the output mode table 34, the output mode information indicative of an output mode of the respective measurement result for each of the measurement item measured by the biometric device 101. Here, the output mode information management section 27b selects one or more of the output mode information from a plurality of output mode information registered in the output mode table 34, based on the safety degrees of the output modes and the confidentiality degrees of the measurement items. More specifically, the safety degrees of the output modes corresponding to the output mode information and the confidentiality degrees of the items of the measurement results outputted in a corresponding output mode are compared; the output mode information indicative of an output mode which has a higher safety degree than the confidentiality degree is selected from the output mode table 34 as a candidate. In a case where one output mode information is selected, the output mode information management section 27b notifies that output mode information to the setting information output section 26. On the other hand, in a case where a plurality of output mode information is selected, the notification section 25 asks the user which output mode to select among the output modes indicated by the plurality of output mode information selected. In response to this, the output mode information management section 27b reads out, from the output mode table 34, the output mode information that is specified by the user, and notifies this to the setting information output section 26.

(Setting Process of Biometric Device by use of Setting Device)

The following description explains a setting process of the biometric device 101 by use of the setting device 7. FIG. 12 illustrates one embodiment of the present invention, and is a flow chart illustrating setting procedures of a biometric device 101 by use of the setting device 7.

When the setting request acquisition section 23 receives a setting request from the biometric device 101 via the communication unit 22 (Yes in S101), the setting request acquisition section 23 consecutively receives a device ID and type ID as device information, from the biometric device 101 (S103). The setting request acquisition section 23 notifies to the setting information management section 27 that the setting request has been received from the biometric device 101, and notifies, to the setting information management section 27, the device ID and type ID thus received.

When the biometric device 101 detects a use by a user from an operation of turning a switch ON or the like, the biometric device 101 is to output a setting request to the setting device 7 via wireless communication. At this time, the biometric device 101 may also notify to the setting device 7 a usable output mode of the biometric device 101. In this example, an output mode usable by the biometric device 101 is set in advance as for example “transfer—with encoding” or “transfer—without encoding” in the biometric device, and the biometric device 101 notifies, to the setting device 7, an output mode that can be outputted by the biometric device 101, while the biometric device 101 outputs the setting request, device ID and type ID.

With a product that uses the biometric device 101 in-home, and which has a linking function such as registering a measurement result in the home gateway 8, and further is in a state straight after purchase (including a case where a resetting process has been carried out after purchase), the biometric device 101 also outputs a setting request of the home gateway 8. In this case (i.e. Yes in S105), when the setting request acquisition section 23 of the setting device 7 acquires the setting request of the home gateway 8, the setting request acquisition section 23 of the setting device 7 notifies to the output mode information management section 27b of the setting information management section 27 acquisition of the setting request of the home gateway 8. In response to this, the output mode information management section 27b reads out the registering destination information 37 from the storage section 30, and the setting information output section 26 transmits to the biometric device 101a local address of the home gateway 8 indicated in the registering destination information 37. As a result, a setting content acquisition section 108 of the biometric devices 101 stores, in the output setting storage section 110, the address received as a registering destination of the measurement result. Thus, the setting of the registering destination is completed (S107).

Subsequently, the output mode information management section 27b registers a device ID and type ID of the biometric device 101 thus purchased to the in-home device table 33 (S109).

In a case where S103 results as No, or as a subsequent step of S109, the user information management section 27a in the setting information management section 27 prepares a list of user information (personal and physical information) to be notified to the biometric device 101 (S111). Following this, the output mode information management section 27b in the setting information management section 27 determines an output mode of the measurement result for each measurement item, respectively (S113). Specific details of S111 and S113 are later described. The setting information output section 26 then notifies to the biometric device the user information prepared in S111 and the output mode determined in S113 (S115). As a result, the setting content acquisition section 108 of the biometric device 101 acquires the setting content, so as to carry out the settings based on the acquired setting content.

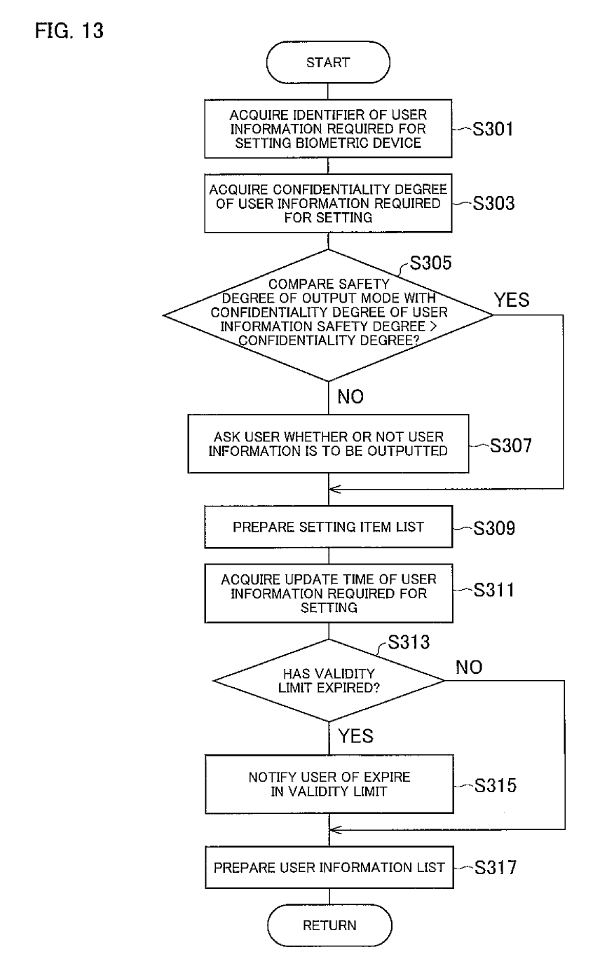

The following description explains a process in the aforementioned S111 in details. FIG. 13 illustrates one embodiment of the present invention, and is a flow chart illustrating detail procedures of S111 in FIG. 12.

First, the user information management section 27a refers to the device setting item table 36 of FIG. 10, so as to specify, based on the type ID of the biometric device 101 thus notified, at least one identifier of user information required by the biometric device 101 as setting information (S301). In other words, the user information management section 27a searches, in the device setting item table 36, for at least one identifier of personal and physical information that correspond to the type ID, which type ID is acquired from the biometric device 101 together with the setting request. In a case where there are a plurality of user information that are required in setting the biometric device 101, that is, in a case where a plurality of identifiers are obtained of the personal and physical information that correspond to the type ID, the processes S303 through S307 described below are repeatedly carried out for each of the user information (i.e. for each of the setting items).

The user information management section 27a acquires a confidentiality degree of the user information required for the setting (S303). More specifically, the user information management section 27a refers to the user information DB 31 of FIG. 5 so as to read out a confidentiality degree that corresponds to the identifier searched in S303.

Subsequently, the user information management section 27a determines whether or not the biometric device 101 which sent the setting device of the setting request is in-home. More specifically, the user information management section 27a refers to the in-home device table 33 of FIG. 7 to check whether or not the device ID notified from the biometric device 101 is included in the in-home device table 33. In a case where the device ID is included, the biometric device 101 that has sent the setting request is determined as one located in-home, and in a case where the device ID is not included, the biometric device 101 is determined as one located outside.

The method for determining whether the biometric device that has sent the setting request is one which is in-home or outside is not limited to the above. For example, whether or not the biometric device 101 that has sent the setting request is in-home or outside may be determined in the following method: the biometric device 101 has location information indicative of whether the device is set in-home or outside (i.e., publicness of the biometric devices 101); the setting device 7 receives this location information from the biometric device 101 as device information, so as to determine, based on this received location information, whether the biometric device 101 is located in-home or outside.

The user information management section 27a then refers to the setting information output safety degree table 35 of FIG. 9, so as to acquire a safety degree of the output mode of the current setting information. For example, the user information management section 27a recognizes that, in a case where the biometric device 101 that sent the setting device of the setting request is located in-home, and the setting information is to be notified in an encoded state, the safety degree is four points, and in a case where the setting information is to be notified not in an encoded state to the biometric device 101 located in-home, the safety degree is five points. Subsequently, the user information management section 27a compares the confidentiality degree of the user information and the safety degree of the current output mode, so as to determine whether or not the safety degree is higher than the confidentiality degree (S305).

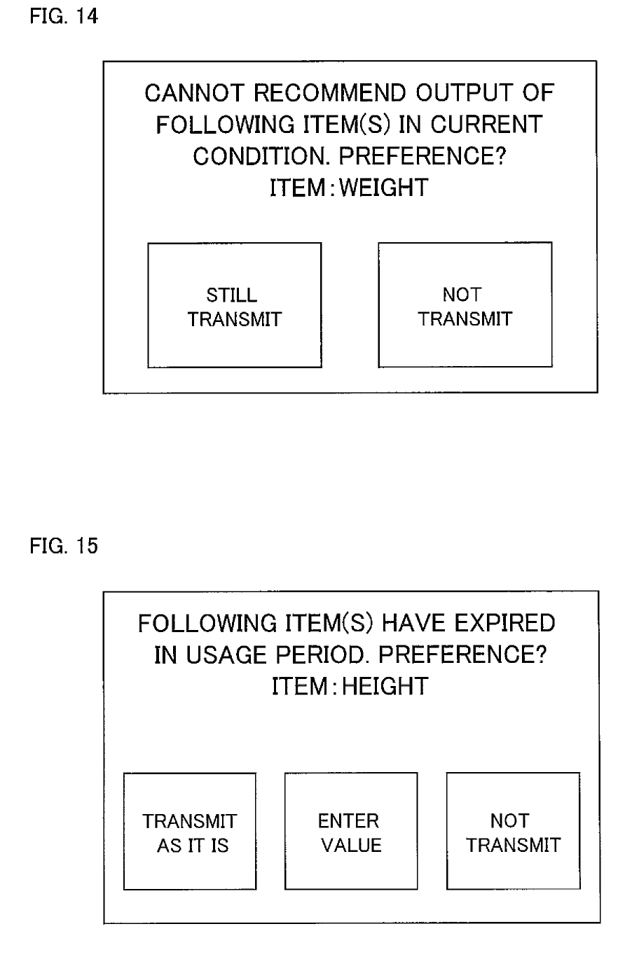

In a case where the safety degree is higher than the confidentiality degree (Yes in S305), the user information management section 27a adds the identifier of the user information acquired in S301 to the setting item list. On the other hand, if the safety degree is not higher than the confidentiality degree (No in S305), the notification section 25 asks the user via the display unit 20 whether or not the user information is to be transmitted (S307). The user information management section 27a either adds the identifier to the setting item list, or removes the identifier, in accordance with the wishes of the user. In the former case, the output information transmitting section 26 transmits the user information, and in the latter case, the output information transmitting section 26 does not transmit the user information. FIG. 14 illustrates one embodiment of the present invention, and is an explanatory view illustrating one example of an inquiry screen to the user that is displayed by the notification section 25, in the case where the safety degree of the output mode is not higher than the confidentiality degree of the user information.

As a modification, in the aforementioned step S305, the user information management section 27a of the setting device 7 may further acquire, as device information, from the biometric device 101, setting information output mode information indicative of an output mode of the setting information so as to specify an output mode of the setting information based on the setting information output mode information, and acquire a safety degree that corresponds to the output mode thus specified from a setting information output safety degree table illustrated in FIG. 9. Alternatively, the user information management section 27a of the setting device 7 may further acquire, from the biometric device 101, as the device information, safety degree information indicative of a safety degree of the output mode of the setting information.

After the processes of S303 through S307 are carried out for all of the user information that correspond to the identifier acquired in S301, a list that shows a view of items of the user information to be notified to the biometric device 101 (hereinafter referred to as “setting item list”) is created (S309).

Subsequently, the user information management section 27a checks whether or not each of the items listed in the setting item list created in S309 have expired in validity limit, through processes S311 through S315 as below.

Namely, the user information management section 27a first acquires, from the user information DB 31 of FIG. 5, a date at which the data is updated corresponding to an identifier listed in the setting item list (S311). Subsequently, the user information management section 27a acquires, from a time limit information table 32 of FIG. 6, a validity period that correspond to the identifier listed in the setting item list. The user information management section 27a then acquires a current date from a timing section not illustrated. Based on the date, validity period and current date thus acquired, the user information management section 27a determines whether or not the user information has expired in its validity limit (S313).

In a case where the user information has exceeded in the validity limit (Yes in S313), the notification section 25 asks the user how to process this user information (S315). Thereafter, in accordance with the wishes of the user, the user information management section 27a either (i) proceeds to the next step without updating the user information, (ii) updates the user information, or (iii) deletes the item (identifier) from the setting item list. FIG. 15 illustrates one embodiment of the present invention, and is an explanatory view illustrating one example of an inquiry screen to the user that is displayed by the notification section 25 in the case where the user information has expired.

The user information management section 27a acquires user information that correspond to each of the identifiers listed in the setting item list from the user information DB 31, and creates a user information list that lists the user information (S317). This completes the process of S1 in FIG. 12.

In the case where the safety degree is lower than the confidentiality degree in S305, the embodiment is arranged such that the notification section 25 asks whether or not to notify the biometric device 101 of the user information. However, the present invention is not limited to this. The present invention may be arranged so that the setting information output section 26 does not notify to biometric device 101 the user information that has the lower safety degree than the confidentiality degree.

Moreover, in the embodiment, an item of the user information that is required by the biometric device 101 is specified based on the type ID received from the biometric device 101, in S301. However, the present invention is not limited to this, and the item of the user information required by biometric device 101 may be specified based on the device ID received from the biometric device 101. More specifically, the user information management section 27a may refer to the in-home device table 33 illustrated in FIG. 7 so as to acquire the type ID that correspond to the device ID received from the biometric device 101, and subsequently refer to the device setting item table 36 illustrated in FIG. 10 so as to acquire an identifier of the user information corresponding to the type ID thus acquired. In this case, the user information required for setting the biometric device 101 can be specified without a need of receiving the type ID indicative of the type of the biometric device 101 from the biometric device 101. Therefore, the device information necessarily received from the biometric device 101 together with the setting request at the time when setting the user information with respect to the biometric device 101 may be any one of the device ID and the type ID of the biometric device 101, and the information is not particularly limited as long as the item of the setting information that is required for setting the biometric device 101 can be specified.

The above describes an embodiment in a case where the setting device 7 is used as a personal terminal. However, the present invention is not limited to this, and also includes a case where the setting device 7 is shared between a multiple number of people. For example, the setting device 7 may include a database that stores user information such as personal and physical information for each user, and the user information management section 27a of the setting device 7 may acquire user identification information (for example, user ID) as one device information, so as to read out, from the database, the user information that corresponds to the user identification information and notify this to the biometric device 101.

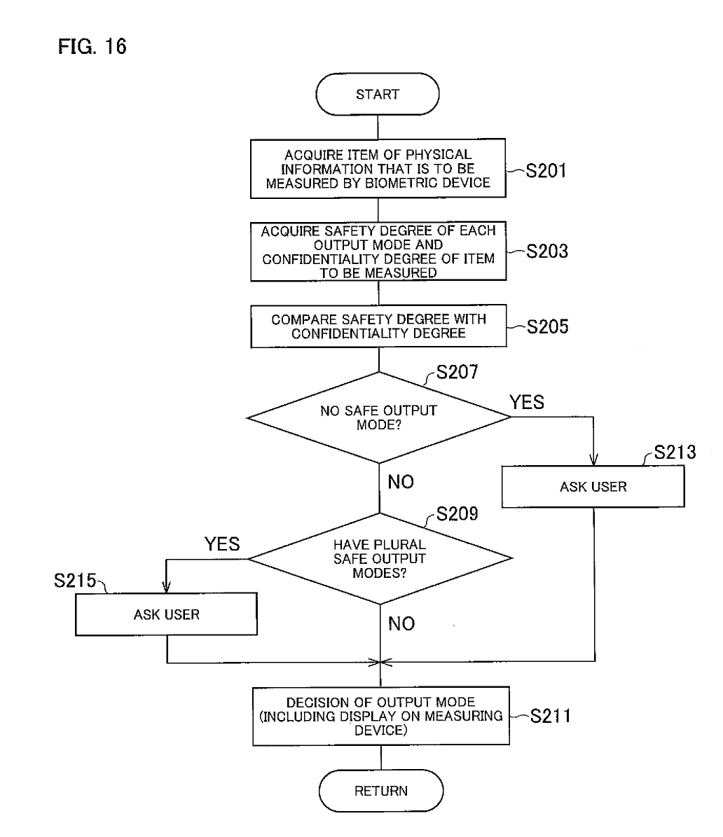

The following description explains the process in S113 in detail. FIG. 16 illustrates one embodiment of the present invention, and is a flow chart illustrating detail procedures in S113 of FIG. 12.

The following description explains an example of a process in which a biometric device 101 outputs a measurement result of a single measurement item, and an output mode of the single measurement result is to be set. In a case where the biometric device outputs measurement results for a plurality of items, the process is to be carried out for each item.

First, the output mode information management section 27b refers to the device setting item table 36 of FIG. 10, so as to acquire an item of physical information that is to be measured by the biometric device 101, based on the type ID transmitted from the biometric device 101 (S201). More specifically, the output mode information management section 27b acquires, in the device setting item table 36 of FIG. 10, an item (identifier) of the physical information corresponding to the type ID acquired from the biometric device 101.

Next, the output mode information management section 27b refers to the user information DB 31 of FIG. 5 so as to acquire a confidentiality degree of the physical information for the item acquired in S201. More specifically, the output mode information management section 27b acquires, from the user information DB 31, the confidentiality degree corresponding to the identifier acquired in S201. In addition, the output mode information management section 27b refers to the output mode table 34 of FIG. 8 so as to acquire safety degrees of each output mode (S203).

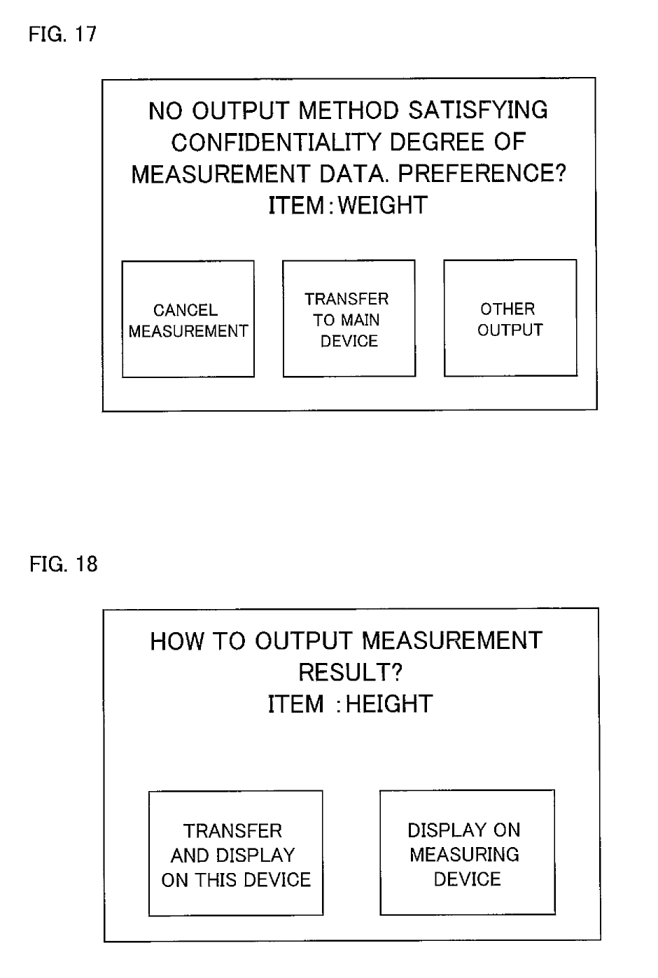

Subsequently, the output mode information management section 27b compares the confidentiality degree and the safety degrees of the output modes acquired in S203 (S205), so as to determine whether or not there is an output mode that has a higher safety degree than the confidentiality degree (S207). In a case where there are no output modes that have the higher safety degree than the confidentiality degree (Yes in S207), the notification section 25 asks the user how to process this physical information (S213). FIG. 17 illustrates one embodiment of the present invention, and is an explanatory view illustrating one example of an inquiry screen to be displayed to the user by the notification section 25 in the case where there are no output modes that has the higher safety degree than the confidentiality degree.

Accordingly, in S207, in a case where there is an output mode that has the higher safety degree than the confidentiality degree, the output mode information management section 27b determines whether or not there are a plurality of output modes that have the higher safety degree than the confidentiality degree (S209). In a case where there is just one output mode that has the higher safety degree than the confidentiality degree (No in S209), the output mode information management section 27b reads out the output mode information corresponding to the safety degree that is higher than the confidentiality degree from the output mode table 34, and notifies this to the setting information output section 26 (S211).

On the other hand, if there are a plurality of output modes that have the higher safety degree than the confidentiality degree (Yes in S209), the notification section 25 asks the user which output mode is desired (S215), and in response, the output mode information management section 27b reads out, from the output mode table 34, the output mode information indicative of the output mode specified by the user (S211). FIG. 18 illustrates one embodiment of the present invention, and is an explanatory view illustrating one example of an inquiry screen to be displayed the user by the notification section 25 in the case where there are a plurality of output modes that have the higher safety degree than the confidentiality degree.

Note that the inquiries made by the notification section 25 is not limited to displaying a message on the display unit 20, and may also be in methods such as notifying the user by audio, by use of an audio output unit.

The above explanation describes a process in which the setting device 7 carries out selection of an item of user information in accordance with the setting request from the biometric device 101, and outputs the user information of the selected item. However, a timing of the setting device 7 for outputting the setting information to the biometric device 101 is not limited to the above. For example, the setting device may acquire device information such as the device ID and type ID of the device via operations of the user by use of the operation entering unit 21 to read out the setting information and output a setting content, each based on this device information as similar to the foregoing embodiment. For example, by displaying, on the display unit 20, a list of items including “pulse rate measuring device 1”, “pace measuring device 2”, “blood pressure measuring device 3”, “body temperature measuring device 4”, “body fat measuring device 5” and “glycosuria measuring device 6”, and having the user select any one of the items, acquisition of the device information (here, the type of biometric device) is possible. Furthermore, preparation of a screen for entering an item of the user information required for measurement and diagnosis as a screen to be displayed when the user selects the item allows the user to select the relevant biometric device 101 to be used and to enter the required setting item by following the entering screen. This thus allows setting of the biometric device 101 thus specified by the user.

Another example is that a timer function may be provided in the setting device 7, and a program which sets what setting information is to be outputted to which of the biometric device 101 at a scheduled time may be incorporated in the setting device 7. This allows regular automatic updating of setting information of the biometric device 101. A timing of automatic transmission may be associated with freshness information (validity period) of the user information. For example, in a case where expired user information is updated, the updated information or the setting information that contains the updated information may be outputted at a timing of update to the biometric device 101 that use this update information as the setting information.

In the present embodiment, the storage section 30 stores, in advance, the device setting item table 36 which lists at least one item of the user information that is required by the biometric device 101 in measurement and diagnosis. However, the item of the user information required in measurement and diagnosis may be received from the biometric devices 101 in S101. In this case, storage capacitance of the storage section 30 is saved, as well as allowing flexible handling of features of biometric devices of various makers.

(Method for Updating Setting Information)

The following description explains a method for updating setting information that is stored in the storage section 30 of the setting device 7. First described is one example of a process of the setting device 7 for regularly determining whether a freshness of data of the user information in the user information DB 31 has decreased. In this example, if the freshness of the data has decreased, the setting device 7 notifies the user of such situation and encourages the user to update the data. This avoids the user to forget updating the data, which enables maintaining the freshness of the data in the user information DB 31 at all times. A method for entering and updating the user information is not limited to the present example, and may adopt a method which automatically updates the user information, or a method in which the user information is updated based on instructions from the user.

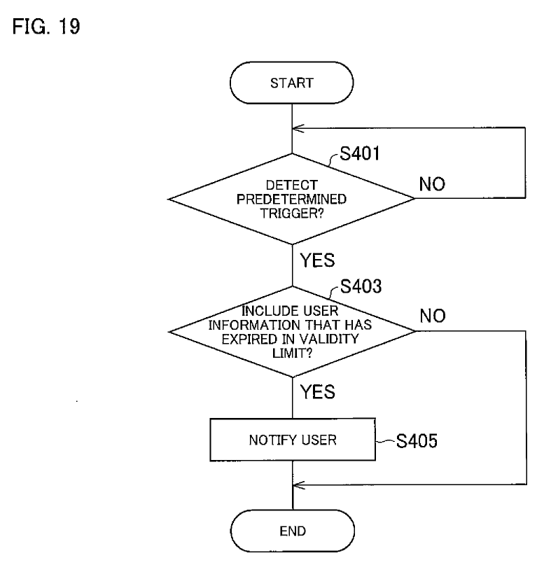

FIG. 19 illustrates one embodiment of the present invention, and is a flow chart illustrating procedures for updating user information stored in the user information DB 31. First, when the user information management section 27a of the setting information management section 27 detects a predetermined trigger (Yes in S401), the user information management section 27a determines whether or not user information that has expired in its validity limit is included in the user information stored in the user information DB 31 (S403). The trigger may be one which, for example, is automatically detected when a predetermined time has elapsed.

Judgment procedures of a validity limit are as follows. The user information management section 27a acquires an updating period of each user information from the user information DB 31 of FIG. 5, and also acquires validity periods of each user information from a validity limit information table of FIG. 6. Subsequently, the user information management section 27a acquires a current date from a timing section not illustrated, so as to determine whether each of the user information is expired, based on the date, updating period and validity limit. In a case where all of the user information are within the validity limit (No in S403), the process ends. On the other hand, in a case where there is user information that has expired in the validity limit (Yes in S403), the notification section 25 notifies the user that the user information has expired in the validity limit. A notification method of the notification section 25 may include methods such as: providing a mailing function to (i) a mobile phone held by a user and (ii) the setting device 7, so as to notify the user by sending a mail to the mobile phone; providing an audio output unit to the setting device 7 so as to notify the user by audio; and providing a vibrator to the setting device 7 so as to notify the user by vibration.

Next is an explanation of processes such as initial registration, addition, correction, and deletion of setting information. There are largely two types of setting information: user information and registering destination information, as described above. Further, two types of data, variable data in which information varies along with an elapse of time and invariant data which is not influenced by the elapse of time, are included in the user information. As described above, the setting device 7 of the present embodiment stores the physical information by classifying the physical information into invariant and variable elements, and for elements that are classified as variable elements, a time attribute is given to the elements.

Methods for entering the setting information include, for example: a method in which a setting information entering format data sheet is prepared in the setting device 7, and the user is to enter setting information via the operation entering unit 21 by following the data sheet; and a method in which a measurement result is registered/updated as the setting information, which measurement result is obtained by actually measuring biometric information (physical information) of a user by use of the biometric device such as the body fat measuring device 5. All of the data obtained due to measurement by the biometric device 101 is considered as variable data. Therefore, the measurement result measured by the biometric device 101 is stored automatically attached with time information. On the other hand, invariant data are to be entered by use of the data sheet.

Procedures for entering the setting information by use of the data sheet are as follows. In the present embodiment, a data sheet is prepared, which data sheet includes items of name, date of birth, sex, registering destination, registering destination network ID, and IP address, and each of the items are tagged to one of the user information and the registering destination information in advance. Further, the name, date of birth and sex in the user information are also tagged as invariant data. Therefore, when the setting information acquisition section 24 receives data entered by the user, the setting information management section 27 stores the data thus entered in the respective item in one of the user information DB 31 and the registering destination information 37, based on the tag information tagged to the items. The invariant data is stored corresponding to updating date information of “Null”.

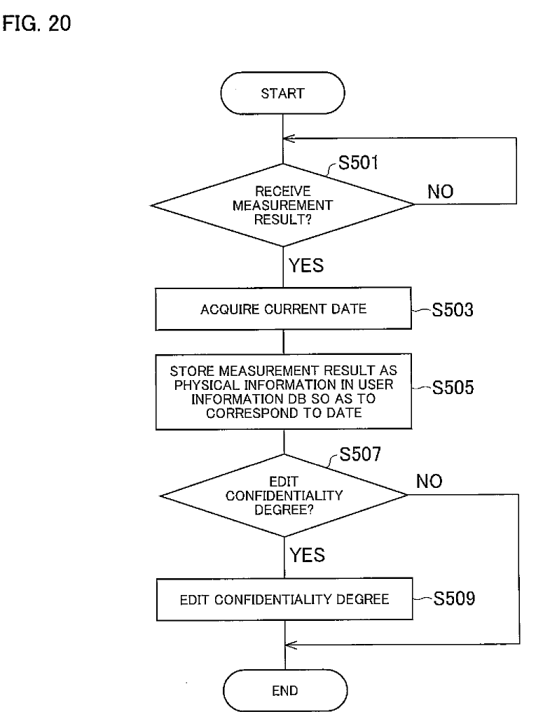

FIG. 20 illustrates one embodiment of the present invention, and is a flow chart illustrating procedures for storing, as user information, a measurement result acquired from the biometric device 101 to the user information DB 31. As described above, the measurement result obtained by the biometric device 101 is recognized as the variable data; updating date information is therefore attached at the time when the measurement result is stored in the user information DR 31. Moreover, an item that is measurable by a respective biometric device 101 such as weight and body fat ratio are stored so as to correspond to the item stored in the user information DB 31 in advance. In the present embodiment, common values are used between the identifier of the user information DB 31 and an item to be measured in the device setting item table 36.

When the user information management section 27a receives a measurement result from the biometric device 101 via a communication unit 22 (Yes in S501), the user information management section 27a acquires a current date from the timing section not illustrated (S503). Subsequently, the user information management section 27a stores the measurement result received in S501 in the user information DB 31 as physical information. The user information management section 27a then correlates the current date acquired in S503 with the physical information thus stored, so that the current date corresponds to the physical information as updating date information (S505).

For example, when measurement results of weight and body fat ratio are acquired from the body fat measuring device 5, the user information management section 27a searches for items of weight and body fat in the user information DB 31, so as to update the physical information corresponding to the items searched. In addition, the user information management section 27a stores current date information as the updating date information so as to correspond to the updated physical information. The user information management section 27a may be arranged such that the user information management section 27a checks a freshness of the physical information that is already stored in the user information DB 31 based on the updated date information of the items thus searched, and in a case where the freshness is still valid, the physical information of the user information DB 31 is not updated.

Subsequently, the notification section 25 asks the user whether or not the confidentiality degree of the updated physical information is to be edited (S507). In a case where the user replies to edit the confidentiality degree (Yes in S507), a confidentiality degree editing data sheet is displayed, so as to have the user edit the confidentiality degree (S509). Note that the confidentiality degree editing data sheet is to be stored in the storage section 30 in advance. On the other hand, in a case where the user replies to not edit the confidentiality degree in S507, the process ends.

As the above, the setting device 7 of the present embodiment includes the storage section 30 (particularly the user information DR 31 and the output mode table 34) for storing the setting information indicative of the setting content to be applied to the biometric device 101, the setting request acquisition section 23 for acquiring the setting request from the biometric device 101, and the setting information output section 26 for notifying, to the biometric device 101, the setting content indicated by the setting information stored in the storage section 30, when the setting request is acquired by the setting request acquisition section 23. This allows carrying out various settings of the biometric device 101 easily, without requiring the user to carry out complex operations to the biometric device 101.

The user information to be used for setting the various biometric devices 101 include many elements that are commonly used between the various biometric devices, such as the date of birth (age in years or months) and sex, and further height, weight, and the like. Carrying out of settings by appropriately selecting the required user information in accordance with the device information of the biometric device 101 allows saving of the storage capacitance and reduction of burden on the user at the time of entering.

The user information DB 31 in the storage section 30 stores, as the setting information, the user information such as the physical or personal information of the user that is to be measured by the biometric device 101. Therefore, setting of the physical or personal information that is required at the time of measurement by the biometric device is easily carried out.

The storage section stores the type ID and the identifier as the device setting item table 36, which type ID is identification information of the biometric device 101 and the identifier is an identifier for specifying respective setting information. The type ID and the identifier are stored so as to correspond to each other. The user information is stored in the user information DB 31 so as to correspond to a respective identifier. The setting request acquisition section 23 acquires the type ID from the biometric device 101. The user information management section 27a (i) reads out, from the device setting item table 36, the identifier that corresponds to the type ID acquired by the setting request acquisition section 23, and (ii) selects, from the user information DB 31, the user information corresponding to the identifier thus read out. The setting information output section 26 notifies, to the biometric device 101, setting content indicated by the setting information selected by the user information management section 27a. Therefore, it is possible to manage the setting information which includes a plurality of items in an integrated manner, and is possible to improve efficiency in management of the setting information.

Moreover, the user information DB 31 of the storage section 30 (i) stores the user information for a plurality of items, and (ii) stores the user information so that the user information corresponds to a confidentiality degree indicative of a degree of confidentiality of respective user information. In a case where the setting request is acquired by the setting request acquisition section 23, the user information management section 27a compares the confidentiality degree stored in the user information DB 31 with a threshold. The notification section 25, based on a comparison made by the user information management section 27a, asks the user whether or not the content of the user information is to be notified to the biometric device 101. This thus allows providing a setting environment in consideration of privacy of a user.

Moreover, in a modification, the user information DB 31 of the storage section 30 (i) stores the user information for a plurality of items, and (ii) stores the user information so that the user information corresponds to a confidentiality degree indicative of a degree of confidentiality of respective user information. In a case where a setting request is acquired by the setting request acquisition section 23, the user information management section 27a selects one or more of user information among the user information stored in the user information DB 31, based on a comparison of the confidentiality degree stored in the user information DB 31 and a threshold. The setting information output section 26 notifies, to the biometric device 101, at least one of the contents of the user information that is selected by the user information management section 27a. Therefore, setting information of which the user does not want a third party to know can be determined based on the confidentiality degree, which allows not notifying such setting information to the biometric device 101. This thus allows providing a setting environment in consideration of privacy of a user.

Note that, in the present embodiment, the threshold is a safety degree indicative of a degree of safety of notification modes to the biometric device 101 by the setting information output section 26. Therefore, in a case the safety of the notification mode cannot be secured (that is, in a case where the notification mode is readily observed), it is possible to not notify a specific content of the setting information to the measuring device. Alternatively, whether or not the information is to be notified can be passed onto the decision of the user. Moreover, the confidentiality degree can be registered and changed by the user.

The user information DB 31 of the storage section 30 stores the user information so that the user information corresponds to a date at which the user information is updated. In a case where it is detected that a validity period indicated in the time limit information table has elapsed after the user information is updated based on the date at which the user information is updated and a timing section not illustrated, the notification section 25 notifies the user so as to encourage the user to update the user information. This allows prevention of a problem of the user forgetting to update the physical or personal information, which results in abandoning of the information for a long period of time. In addition, it is possible to prevent measurement and diagnosis to be carried out based on old invalid biometric information such as weight. Furthermore, the user is provoked in updating the physical information regularly or frequently, which enhances consciousness towards daily health of the user. The validity period is set in accordance with the types of physical information, therefore updating of the physical information that is relatively invariant such as height is not so requested to be updated as frequently as weight. Needless to say, the validity period may be determined by not just the types of physical information, but also adding other causes such as a purpose of the measurement.

The output mode table 34 of the storage section 30 stores, as the setting information, one or more output mode information indicative of the one or more output modes of respective one or more measurement results measured by the biometric device 101. Therefore, it is possible to easily carry out setting of the output mode that is required at the time when the measurement result is outputted by the biometric device 101.

Moreover, the output mode table 34 of the storage section 30 stores a plurality of output mode information including first output mode information indicative of an output mode for notifying the user of the measurement result by use of the biometric device 101 and second output mode information indicative of an output mode for notifying the user of the measurement result by use of the notification section 25 of the setting device 7. In a case where the setting request acquisition section 23 acquires a setting request, the output mode information management section 27b of the setting information management section 27 selects output mode information from the output mode table 34. The setting information output section 26 notifies, to the biometric device 101, the output mode indicated by the output mode information selected by the output mode information management section 27b. Therefore, it is possible to display the measurement result as follows: when, for example, biometric information is measured by use of the biometric device 101 located in public, measurement results such as height that has no damage in having parties other than a third party know of such information are displayed on the biometric device, however measurement results such as weight that is desirably not known by the third parties are displayed on a setting device 7 held by the user.

The user information DB 31 of the storage section 30 stores a confidentiality degree indicative of a degree of confidentiality of a respective measurement result measured by the biometric device 101. The output mode table 34 of the storage section 30 stores a plurality of the output mode information of different output modes. In a case where the setting request acquisition section 23 acquires the setting request, the output mode information management section 27b selects the output mode information from the output mode table 34 based on the confidentiality degree. The setting information output section 26 notifies, to the biometric device 101, the output mode indicated by the output mode information selected by the output mode information management section 27b. Therefore, it is possible to set the setting device to notify the user of the measurement result in a suitable output mode, and set the biometric device 101 so that the output mode is set in consideration of the privacy of the user.

The output mode table 34 of the storage section 30 stores a plurality of output mode information that have different output modes, and stores the output mode information so that the output mode information corresponds to a safety degree indicative of a degree of safety of the respective output mode, which output mode is indicated by the output mode information. In the case where the setting request acquisition section 23 acquires the setting request, the output mode information management section 27b selects output mode information from the output mode table 34 based on the safety degree. The setting information output section 26 notifies, to the biometric device 101, the output mode indicated by the output mode information selected by the output mode information management section 27b. Therefore, determination of the output mode of the measurement result can be made in consideration of the safety degree of the output mode.

The user information DB 31 of the storage section 30 stores the confidentiality degree indicative of the degree of confidentiality of the measurement result measured by the biometric device 101. The output mode table 34 of the storage section 30 (i) stores a plurality of output mode information having different output modes, and (ii) stores the output mode information so that the output mode information correspond to the safety degree indicative of the degree of safety of the respective output mode indicated by the output mode information. In the case where the setting request acquisition section 23 acquires the setting request, the output mode information management section 27b selects the output mode information from the output mode table 34 based on the confidentiality degree stored in the user information DB 31 and the safety degree stored in the output mode table 34. The setting information output section 26 notifies, to the biometric devices 101, the output mode indicated by the output mode information selected by the output mode information management section 27b. Therefore, it is possible to set the biometric device 101 so that the biometric device 101 is set to have an appropriate output mode, in consideration of the confidentiality degrees of the measurement result and the safety degree of the output modes.

Moreover, the output mode information management section 27b selects a plurality of candidates among the output mode information stored in the output mode table 34 of the storage section 30, and the setting information output section 26 notifies, to the biometric device 101, an output mode indicated by any one of the output mode information that is specified by a user, among the candidates selected by the output mode information management section 27b. Therefore, setting of the output mode in consideration of wishes of the user is possible.

Note that in the present embodiment, it is possible for the user to set the confidentiality degree and the safety degree.

The storage section 30 stores, as the setting information, registering destination information 37 indicative of a destination at which the measurement result measured by the biometric device 101 is to be registered. Therefore, setting of such destination with respect to the biometric device 101 can be easily carried out.

Moreover, the setting device 7 has a communication unit 22 for carrying out wireless communication with the biometric device 101. The setting information output section 26 transmits the setting contents to the biometric device 101 via wireless communication by use of the communication unit 22. Therefore, it is possible to eliminate a need to carry out any special operations when setting the biometric devices 101, such as having the setting device 7 have contact with the biometric device 101, connecting the setting device 7 and the plurality of biometric devices 101 with a cable, or the like.

Similarly, the notification section 25 receives the measurement result via wireless communication from the biometric device 101 by use of the communication unit 22. Therefore, it is possible to eliminate a need to carry out any special operations when setting the biometric device 101, such as having the setting device 7 have contact with the biometric devices 101, connecting the setting device 7 and the biometric device 101 with a cable, or the like.

Moreover, the present embodiment has the setting device 7 incorporated in a mobile phone. This allows providing the user a comfortable usage environment of the biometric device 101, without a need for the user to hold a further device.

Finally, each of the sections of the biometric device 101 and setting device 7 may be realized by way of hardware or software as executed by a CPU as follows:

The setting device 7 includes a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the biometric device 101 or setting device 7 a computer-readable storage medium containing control program code (executable program, intermediate code program, or source program) for the biometric devices 101 or setting device 7, which is software realizing the aforementioned functions, in order for the computer (or CPU, MPU) to retrieve and execute the program code contained in the storage medium.

The recording medium may be, for example, a tape, such as a magnetic tape or a cassette tape; a disk including a magnetic disk, such as a floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The biometric device 101 or setting device 7 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth®, 802.11 wireless, HDR, mobile telephone network, satellite line, or terrestrial digital network. The present invention encompasses a carrier wave or data signal transmission in which the program code is embodied electronically.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

As described above, a setting device according to the present invention includes: a setting information storage section for storing a plurality of setting information indicative of setting contents to be applied to the biometric device; a device information acquisition section for acquiring device information related to the biometric device; a setting information management section for reading out, from the setting information storage section, one or more of the setting information based on the device information acquired by the device information acquisition section; and a setting information output section for notifying the biometric device of at least one of the setting contents indicated by the setting information read out by the setting information management section.

A biometric device according to the present invention includes: a device information notification section for notifying device information to an external device, the device information being information related to the biometric device; a setting content acquisition section for acquiring a setting content that is returned in accordance with the device information notified by the device information notification section; and a setting section for carrying out a setting based on the setting content acquired by the setting content acquisition section.

Another setting device according to the present invention includes: a setting information storage section for storing setting information indicative of setting contents to be applied to the biometric device; a setting request acquisition section for acquiring a setting request from the biometric device; and a setting information output section for notifying the biometric device of at least one of the setting contents indicated by the setting information stored in the setting information storage section.

Therefore, as described above, various settings of the biometric device is easily carried out.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

According to the present invention, settings of various biometric devices are easily carried out. Therefore, the present invention is suitably used for medical related devices.

1. A setting device for setting a biometric device that measures information related to a living body, the setting device comprising:
a setting information storage section for storing a plurality of setting information indicative of setting contents to be applied to the biometric device;
a device information acquisition section for acquiring device information related to the biometric device;
a setting information management section for reading out, from the setting information storage section, one or more of the setting information based on the device information acquired by the device information acquisition section; and
a setting information output section for notifying the biometric device of at least one of the setting contents indicated by the setting information read out by the setting information management section.

2. The setting device as set forth in claim 1, wherein the device information is information for specifying a type of setting information required for setting the biometric device.

3. The setting device as set forth in claim 2, wherein the setting information storage section stores, as the setting information, physical or personal information of a user who is to be measured by the biometric device.

4. The setting device as set forth in claim 3, further comprising:
a validity period storage section for storing validity period information indicative of a validity period of respective setting information stored in the setting information storage section; and
a notification section for notifying a user in a case where the validity period is detected to have elapsed, the validity period being measured starting upon preparation or registration of the setting information stored in the setting information storage section and being indicated by the validity period information stored in the validity period storage section.

5. The setting device as set forth in claim 3, further comprising:
a setting item storage section for storing the device information and a setting information identifier so that the device information and the setting information identifier correspond to each other, the setting information identifier being an identifier for specifying respective setting information,
the setting information storage section (i) storing the setting information for a plurality of items, and (ii) storing each of the setting information so that the setting information corresponds to a respective setting information identifier,
the setting information management section (i) reading out, from the setting item storage section, a setting information identifier that corresponds to the device information acquired by the device information acquisition section, and (ii) selecting, from the setting information storage section, setting information that corresponds to the setting information identifier thus read out, and
the setting information output section notifying the biometric device of a setting content indicated by the setting information selected by the setting information management section.

6. The setting device as set forth in claim 3, wherein:
the setting information storage section (i) stores the setting information for a plurality of items, and (ii) stores each of the setting information so that the setting information corresponds to a confidentiality degree indicative of a degree of confidentiality of respective setting information, the setting information management section selects one or more of setting information among the setting information stored in the setting information storage section, based on a comparison of the confidentiality degree stored in the setting information storage section and a predetermined threshold, and
the setting information output section notifies the biometric device of at least one of setting contents indicated by the setting information selected by the setting information management section.

7. The setting device as set forth in claim 3, further comprising:
a notification section,
the setting information storage section (i) storing the setting information for a plurality of items, and (ii) storing the setting information so that the setting information corresponds to a confidentiality degree indicative of a degree of confidentiality of respective setting information, the setting information management section comparing the confidentiality degree stored in the setting information storage section with a predetermined threshold, and
in accordance with a comparison result by the setting information management section, the notification section asking a user whether or not to notify the biometric device of the at least one of the setting contents indicated by the setting information.

8. The setting device as set forth in claim 6, wherein the setting information management section compares the confidentiality degree with a threshold set based on device information acquired by the device information acquisition section.

9. The setting device as set forth in claim 6, wherein the threshold is based on a degree of safety of how the setting information output section notifies the biometric device.

10. The setting device as set forth in claim 3, further comprising:
a notification section for notifying a user; and
a timing section,
the setting information storage section storing the setting information so that the setting information corresponds to a time at which the setting information is prepared or updated, and
the notification section notifying to the user an elapse of a predetermined period when the elapse is detected based on the time and the timing section after the setting information is prepared or updated.

11. The setting device as set forth in claim 10, wherein:
the setting information storage section stores the setting information for a plurality of items, and the predetermined period varies depending on the items of the setting information.

12. The setting device as set forth in claim 10, wherein the notification section notifies the user so as to encourage updating of the setting information.

13. The setting device as set forth in claim 1, wherein:
the setting information storage section stores, as the setting information, one or more output mode information indicative of one or more output modes of respective one or more measurement results measured by the biometric device,
the device information is information for specifying a respective measurement item of the biometric device,
the setting information management section specifies the measurement item of the biometric device based on the device information acquired by the device information acquisition section so as to select, based on the measurement item thus specified, the output mode information from the setting information storage section, and
the setting information output section notifies the biometric device of a setting content indicated by the output mode information selected by the setting information management section.

14. The setting device as set forth in claim 13, further comprising:
a notification section for acquiring the measurement result so as to notify a user of them,
the setting information storage section storing a plurality of output mode information including first output mode information and second output mode information, the first output mode information being indicative of an output mode for notifying the user of the measurement result by use of the biometric device, and the second output mode information being indicative of an output mode for notifying the user of the measurement result by use of the notification section.

15. The setting device as set forth in claim 13, further comprising:
a confidentiality degree storage section for storing a confidentiality degree so that the confidentiality degree corresponds to a respective measurement item of the biometric device, the confidentiality degree being indicative of a degree of confidentiality of the measurement item,
the setting information management section reading out the confidentiality degree of a specified measurement item from the confidentiality degree storage section so as to select the output mode information from the setting information storage section based on the confidentiality degree thus read out.

16. The setting device as set forth in claim 13, wherein:
the setting information storage section stores each of the output mode information so that the output mode information corresponds to a safety degree indicative of a degree of safety of a respective output mode, the degree of safety of the output mode being indicated by the output mode information,
the setting information management section selects the output mode information from the setting information storage section based on a specified measurement item and the safety degree.

17. The setting device as set forth in claim 13, further comprising:
a confidentiality degree storage section for storing a confidentiality degree so that the confidentiality degree corresponds to a respective measurement item of the biometric device, the confidentiality degree being indicative of a degree of confidentiality of the measurement item,
the setting information storage section storing each of the output mode information so that the output mode information corresponds to a safety degree indicative of a degree of safety of a respective output mode, the degree of safety of the output mode being indicated by the output mode information, and
the setting information management section reading out the confidentiality degree corresponding to a specified measurement item from the confidentiality degree storage section so as to select the output mode information from the setting information storage section based on the confidentiality degree thus read out and the safety degree.

18. The setting device as set forth in claim 14, wherein:
the setting information management section selects a plurality of candidates among the output mode information stored in the setting information storage section, and
the setting information output section notifies the biometric device of an output mode indicated by any one of the output mode information that is specified by a user, among the candidates selected by the setting information management section.

19. The setting device as set forth in claim 13, wherein the setting information storage section stores, as the setting information, registering destination information indicative of a destination at which the measurement result measured by the biometric device is to be registered.

20. The setting device as set forth in claim 1, further comprising:
a wireless communication unit for carrying out wireless communication with the biometric device,
the setting information output section transmitting at least one of the setting contents to the biometric device via the wireless communication unit.

21. The setting device as set forth in claim 14, further comprising:
a wireless communication unit for carrying out wireless communication with the biometric device,
the notification section receiving the measurement result from the biometric device via the wireless communication unit.

22. The setting device as set forth in claim 1, wherein the device information acquisition section acquires the device information from the biometric device.

23. The setting device as set forth in claim 1, further comprising:
an operation entering unit,
the device information acquisition section acquiring the device information via the operation entering unit.

24. The setting device as set forth in claim 1, wherein the setting device is a mobile phone.

25. (canceled)

26. (canceled)

27. A biometric device for measuring biometric information, comprising:
a device information notification section for notifying device information to an external device, the device information being information related to said biometric device;
a setting content acquisition section for acquiring a setting content that is returned in accordance with the device information notified by the device information notification section; and
a setting section for carrying out a setting based on the setting content acquired by the setting content acquisition section.

28. (canceled)

29. (canceled)

30. A system for setting a biometric device, said system comprising: a biometric device for measuring biometric information; and a setting device for setting the biometric device, said setting device including:
a setting information storage section for storing a plurality of setting information indicative of setting contents to be applied to the biometric device;
a device information acquisition section for acquiring device information related to the biometric device;
a setting information management section for reading out, from the setting information storage section, one or more of the setting information based on the device information acquired by the device information acquisition section; and
a setting information output section for notifying the biometric device of at least one of the setting contents indicated by the setting information read out by the setting information management section, and
said biometric device including:
a device information notification section for notifying the device information to the setting device;
a setting content acquisition section for acquiring a setting content to be notified from the setting device; and
a setting section for carrying out a setting based on the setting content acquired by the setting content acquisition section.

31. (canceled)
